(19) United States
(12) Patent Application Publication
(10) Pub. No.: US 2014/0309963 A1
(43) Pub. Date: Oct. 16, 2014

(54) POSITIONING APPARATUS, COMPUTER PROGRAM, AND APPLIANCE CONTROL SYSTEM

(71) Applicants: Takeo Tsukamoto, Kanagawa (JP); Hajime Yuzurihara, Kanagawa (JP); Takanori Inadome, Kanagawa (JP); Hideaki Aratani, Kanagawa (JP)

(72) Inventors: Takeo Tsukamoto, Kanagawa (JP); Hajime Yuzurihara, Kanagawa (JP); Takanori Inadome, Kanagawa (JP); Hideaki Aratani, Kanagawa (JP)

(21) Appl. No.: 14/357,918

(22) PCT Filed: Aug. 6, 2013
(86) PCT No.: PCT/JP13/71748

§ 371 Date: May 13, 2014

(30) Foreign Application Priority Data
Aug. 6, 2012 (JP) 2012-174388
May 14, 2013 (JP) 2013-102437

(51) Int. Cl. G01B 7/00

(52) U.S. Cl. CPC G01B 7/003
USPC 702/150

(57) ABSTRACT

A positioning apparatus for measuring a position of a mobile object in a target area, the positioning apparatus includes: an estimation unit configured to estimate a first position, the first position being a relative to a reference position of the mobile object; an acquisition unit configured to acquire power information of an electrical appliance provided in the target area; and a correction unit configured to correct the first position for a second position on the basis of the power information of the electrical appliance and positional information indicating the second position of the electrical appliance.

### TECHNICAL FIELD

The present invention relates to a positioning apparatus, a computer program, and an appliance control system.

### BACKGROUND ART

Dead reckoning has been known as a method for estimating positions of mobile objects. In the dead reckoning, a relative position of a mobile object to a reference position is estimated on the basis of detection data of an acceleration sensor, an angular velocity sensor, and a geomagnetic sensor attached to the mobile object (e.g., refer to Patent Literature 1). Therefore, errors in the detection data accumulate when a moving distance from the reference position increases, thereby lowering reliability of the estimated position.

To make up for such a shortcoming of the dead reckoning and to detect the accurate position, the position estimated by the dead reckoning is conventionally corrected using techniques such as Global Positioning System (GPS) and radio frequency identification (RFID) to identify an absolute position of the mobile object.

### CITATION LIST

### Patent Literature

PTL1: Japanese Patent Application Laid-open No. 2011-47950

### SUMMARY OF INVENTION

### Technical Problem

The use of the techniques such as the GPS and the RFID to correct the position estimated by the dead reckoning in a conventional manner requires an extensive system, resulting in a problem of an increase in cost and the like.

In view of such problems, the present invention is made and aims mainly to provide a positioning apparatus, a computer program, and an appliance control system that can measure the position of a mobile object with a high accuracy employing a simple structure.

### Solution to Problem

According to an aspect of the invention, a positioning apparatus for measuring a position of a mobile object in a target area is provided. The positioning apparatus includes: an estimation unit configured to estimate a first position, the first position being a relative to a reference position of the mobile object; an acquisition unit configured to acquire power information of an electrical appliance provided in the target area; and a correction unit configured to correct the first position for a second position on the basis of the power information of the electrical appliance and positional information indicating the second position of the electrical appliance.

According to another aspect of the invention, a computer readable storage medium including computer executable instructions configured to perform a method is provided. The method includes: estimating a first position, the first position being a relative position to a reference position of the mobile object in a target area; acquiring power information of an electrical appliance provided in the target area; and correcting the first position for a second position on the basis of the power information of the electrical appliance and positional information indicating the second position of the electrical appliance.

According to further aspect of the invention, an appliance control system, including: a positioning apparatus for measuring a position of a mobile object in a control target area; and a control apparatus connected to the positioning apparatus over a network and controlling an electrical appliance installed in the control target area is provided. The positioning apparatus includes: an estimation unit configured to estimate a first position, the first position being a relative to a reference position of the mobile object in the control target area; an acquisition unit configured to acquire power information of an electrical appliance provided in the control target area; and a correction unit configured to correct the first position for a second position on the basis of the power information of the electrical appliance and positional information indicating the second position of the electrical appliance. The control apparatus includes: a receiving unit configured to receive information indicating the corrected position of the mobile object from the positioning apparatus; and an appliance control unit configured to control the electrical appliance on the basis of the corrected position of the mobile object.

### Advantageous Effects of Invention

The present invention has an advantage of being capable of measuring the position of the mobile object with a high accuracy employing a simple structure.

### BRIEF DESCRIPTION OF DRAWINGS

FIG. 1 is a block diagram illustrating a schematic structure of a positioning apparatus of an embodiment.

FIG. 2 is a network structural diagram of an appliance control system of the embodiment.

FIG. 3 is a schematic diagram illustrating an attachment condition of a smartphone.

FIG. 4 is a schematic diagram illustrating an example in which an information appliance that can detect motions of an employee is attached separately from the smartphone.

FIG. 5 is a schematic diagram illustrating detection directions of respective sensors.

FIG. 6 is a schematic diagram illustrating an example of an installation condition of monitoring cameras.

FIG. 7 is a schematic diagram illustrating an example of an installation condition of LED-lighting appliances, power strips, and air-conditioners.

FIG. 8 is a schematic diagram explaining an example of a method in which a control server apparatus collects power information from the power strip.

FIG. 9 is a block diagram illustrating a functional structure of a positioning server apparatus.

FIG. 10 is a schematic diagram illustrating a waveform of an acceleration component in the vertical direction when a sitting down motion and a standing up motion are performed.

FIG. 11 is a schematic diagram illustrating a waveform of an angular velocity component in the horizontal direction when a squatting motion and a standing up motion are performed.

FIG. 12 is a schematic diagram illustrating a waveform of the angular velocity component in the vertical direction when a motion of changing a facing direction is performed in a stationary condition.

FIG. 13 is a schematic diagram illustrating a waveform of the angular velocity component in the horizontal direction of a head when a direction of eyes is changed in an upward direction away from a display in a sitting condition.

FIG. 14 is a schematic diagram illustrating a waveform of the angular velocity component in the horizontal direction of a head when a direction of eyes is changed in a downward direction away from a display in a sitting condition.

FIG. 15 is a block diagram illustrating a functional structure of the control server apparatus of the embodiment.

FIG. 16 is a schematic diagram explaining a flow of information handled in the appliance control system of the embodiment.

FIG. 17 is a flowchart illustrating a procedure of detection processing by the positioning server apparatus of the embodiment.

FIG. 18 is a flowchart illustrating a procedure of position correction processing of the embodiment.

FIG. 19 is a flowchart illustrating a procedure of appliance control processing of the embodiment.

### DESCRIPTION OF EMBODIMENTS

An embodiment of a positioning apparatus, a computer program, and an appliance control system according to the invention is described in detail below with reference to the accompanying drawings.

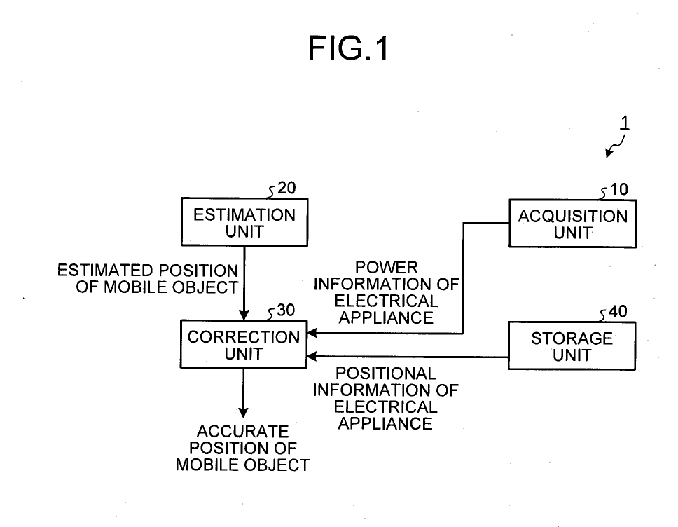

The following describes an overview of the positioning apparatus of the embodiment with reference to FIG. 1. FIG. 1 is a block diagram illustrating a schematic structure of a positioning apparatus 1 of the embodiment. As illustrated in FIG. 1, the positioning apparatus 1 includes an acquisition unit 10, an estimation unit 20, a correction unit 30, and a storage unit 40.

The acquisition unit 10 acquires power information indicating power consumption of various electrical appliances arranged in a control target area. The power information of the electrical appliances can be acquired from an external apparatus having a function to collect the power information and manage the power consumption of each electrical appliance, for example. The power information of the electrical appliance may be acquired directly from the electrical appliance. When the electrical appliance is connected to a power strip having a communication function or the like, the power information may be acquired from the power strip.

The storage unit 40 stores therein positional information indicating a position of the electrical appliance in the control target area. The position of the electrical appliance indicated by the positional information does not necessarily mean the position of a main body unit of the electrical appliance. For example, when the main body unit of the electrical appliance and an operating unit operated for using the electrical appliance are installed spaced apart from each other, the position of the electrical appliance indicated by the positional information is the position of the operating unit of the electrical appliance. When the electrical appliance operates on the basis of a detection result of a human sensor or an object detection sensor, the position of the electrical appliance indicated by the positional information is the position of a detection target area by the human sensor or the object detection sensor. The positioning apparatus 1 may employ a structure in which the positional information of the electrical appliance is acquired from an external apparatus without being provided with the storage unit 40.

The estimation unit 20 estimates the position of the mobile object in the control target area. As a method for estimating the position of the mobile object, a dead reckoning method described in Patent Literature 1 may be used, for example. That is, the estimation unit 20 can estimate the relative position of the mobile object to the reference position on the basis of detection data of an acceleration sensor, an angular velocity sensor, and a geomagnetic sensor attached to the mobile object. The estimation unit 20 may estimate the position of the mobile object by methods other than the dead reckoning, e.g., by analyzing an image of a camera photographing the control target area, or may estimate the position of the mobile object by combining such a method and the dead reckoning.

The correction unit 30 corrects the position of the mobile object estimated by the estimation unit 20 on the basis of the power information acquired by the acquisition unit 10 and the positional information of the electrical appliance stored in the storage unit 40. For example, the correction unit 30 refers to the positional information of the electrical appliance and identifies the electrical appliance in the vicinity of the position of the mobile object estimated by the estimation unit 20. When it is determined that the power consumption of the electrical appliance largely changes on the basis of the power information acquired by the acquisition unit 10, the correction unit 30 corrects the position of the mobile object estimated by the estimation unit 20 to the position of the electrical appliance.

When the mobile object such as a human or a working robot approaches to and operates the electrical appliance, the power consumption of the electrical appliance changes largely. In other words, when the power consumption of the electrical appliance changes largely, it can be determined that the mobile object that operates the electrical appliance is present at the position of the electrical appliance. On the basis of such knowledge, the positioning apparatus 1 of the embodiment includes the correction unit 30 that corrects the position of the mobile object estimated by the estimation unit 20 on the basis of the power information indicating the power consumption of the electrical appliance and the positional information of the electrical appliance. As a result, the positioning apparatus 1 of the embodiment can measure the position of the mobile object with a high accuracy and detect the accurate position of the mobile object employing a simple structure.

The following describes an example in which the positioning apparatus 1 of the embodiment is applied to an appliance control system that controls power of each of the various appliances installed in a room in accordance with the position or the like of a human who performs a specific task (hereinafter called an employee) in the room serving as the control target area.

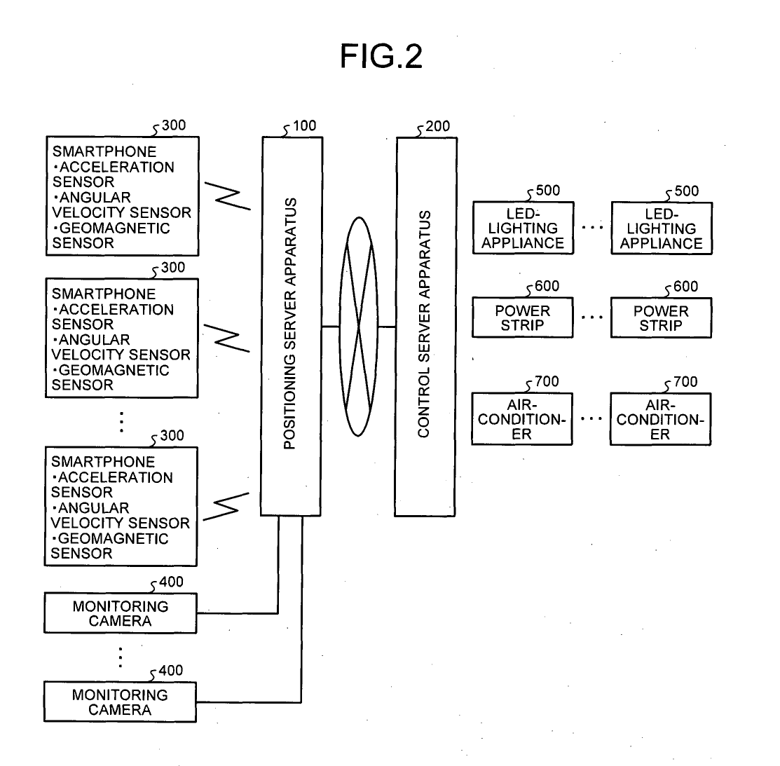

FIG. 2 is a network structural diagram of the appliance control system of the embodiment. As illustrated in FIG. 2, the appliance control system of the embodiment includes a plurality of smartphones 300, a plurality of monitoring cameras 400, a positioning server apparatus 100 having the function of the positioning apparatus 1 illustrated in FIG. 1, a control server apparatus 200, and a plurality of light emitting diode (LED)-lighting appliances 500, a plurality of power strips 600, and a plurality of air-conditioners 700 that are control targets.

The smartphones 300, the monitoring cameras 400, and the positioning server apparatus 100 are connected through a wireless communication network such as Wi-Fi (Wireless Fidelity), for example. The wireless communication scheme is not limited to Wi-Fi. The monitoring cameras 400 and the positioning server apparatus 100 may be connected in a wired manner.

The positioning server apparatus 100 and the control server apparatus 200 are connected to a network such as the Internet or a local area network (LAN).

The control server apparatus 200 and the LED-lighting appliances 500, the power strips 600, and the air-conditioners 700 are connected through a wireless communication network such as Wi-Fi, for example.

The communication scheme between the control server apparatus 200 and the LED-lighting appliances 500, the power strips 600, and the air-conditioners 700 is not limited to Wi-Fi. Other communication schemes may be used. A wired-communication scheme such as an Ethernet (registered trademark) cable or power line communications (PLC) can be used.

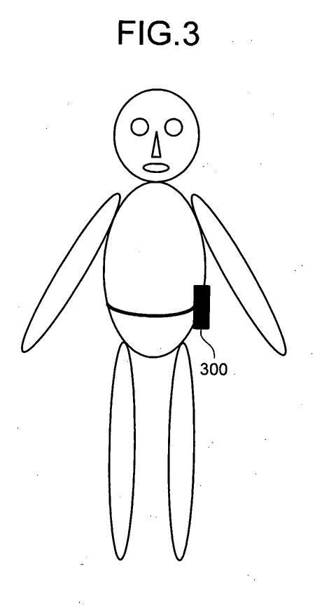

The smartphone 300 is an information appliance that is carried by the employee and detects motions of the employee. FIG. 3 is a schematic diagram illustrating an attachment condition of the smartphone 300. The smartphone 300 may be attached to the waist of the employee as illustrated in FIG. 3 besides being carried by hand or the like by the employee.

Referring back to FIG. 2, the smartphones 300 each mounted with an acceleration sensor, an angular velocity sensor, and a geomagnetic sensor transmit the detection data of the respective sensors to the positioning server apparatus 100 at constant time intervals such as one second. The detection data of the acceleration sensor is an acceleration vector. The detection data of the angular velocity sensor is an angular velocity vector. The detection data of the geomagnetic sensor is a magnetic direction vector.

In the embodiment, the smartphone 300 is used as the information appliance detecting motions of the employee. The information appliance, however, is not limited to a mobile terminal such as the smartphone 300. Any information appliance is applicable that includes an acceleration sensor, an angular velocity sensor, and a geomagnetic sensor and that can detect human motions.

A structure may be applicable in which the smartphone 300 is provided with an information appliance such as the acceleration sensor, the angular velocity sensor, and the geomagnetic sensor detecting the motions of the employee, and another information appliance detecting the motions of the employee is attached separately from the smartphone 300.

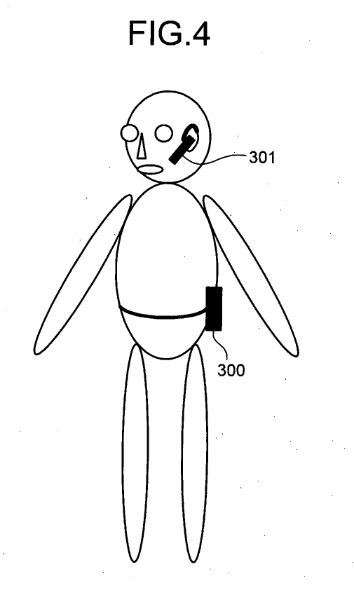

For example, FIG. 4 is a schematic diagram illustrating an example in which an information appliance that can detect the motions of the employee is attached separately from the smartphone 300. As illustrated in FIG. 4, it is possible to attach a small head-set type sensor group 301 including an acceleration sensor, an angular velocity sensor, and a geomagnetic sensor to the head of the employee separately from the smartphone 300. In this case, the detection data detected by the sensor group 301 is transmitted directly to the positioning server apparatus 100 by the sensor group 301, and can be also transmitted to the positioning server apparatus 100 through the smartphone 300. The sensor group 301 attached to the head of the employee separately from the respective sensors of the smartphone 300 makes it possible to detect various postures.

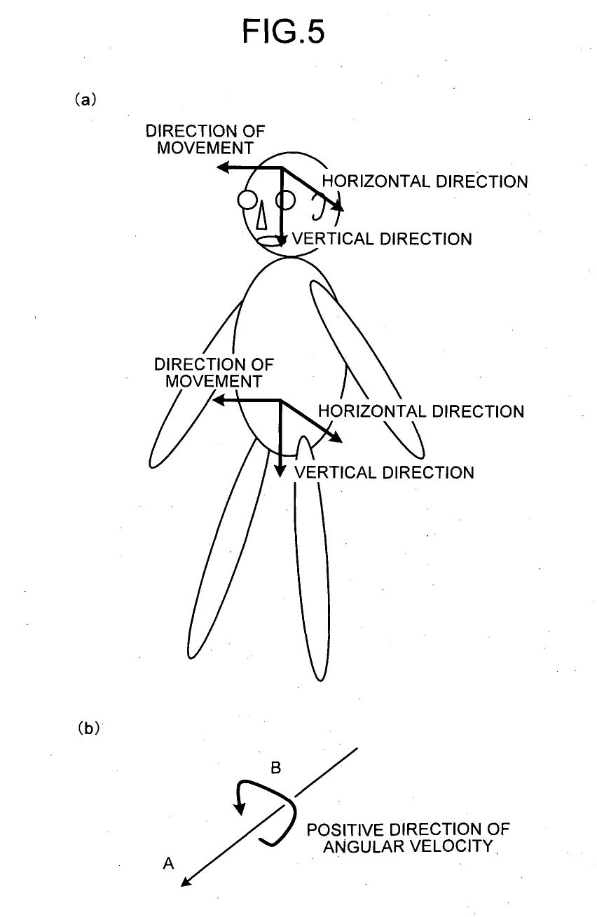

FIG. 5 is a schematic diagram illustrating detection directions of the respective sensors. FIG. 5(a) illustrates the detection directions of the acceleration sensor and the geomagnetic sensor. As illustrated in FIG. 5(a), acceleration components and geomagnetic direction components in a direction of movement, the vertical direction, and the horizontal direction are respectively detectable by the acceleration sensor and the geomagnetic sensor. FIG. 5(b) illustrates an angular velocity vector A detected by the angular velocity sensor. Arrow B indicates the positive direction of the angular velocity. In the embodiment, respective projections of the angular velocity vector A in the direction of movement, the vertical direction, and the horizontal direction illustrated in FIG. 5(a) are referred to as the angular velocity component in the direction of movement, the angular velocity component in the vertical direction, and the angular velocity component in the horizontal direction, respectively.

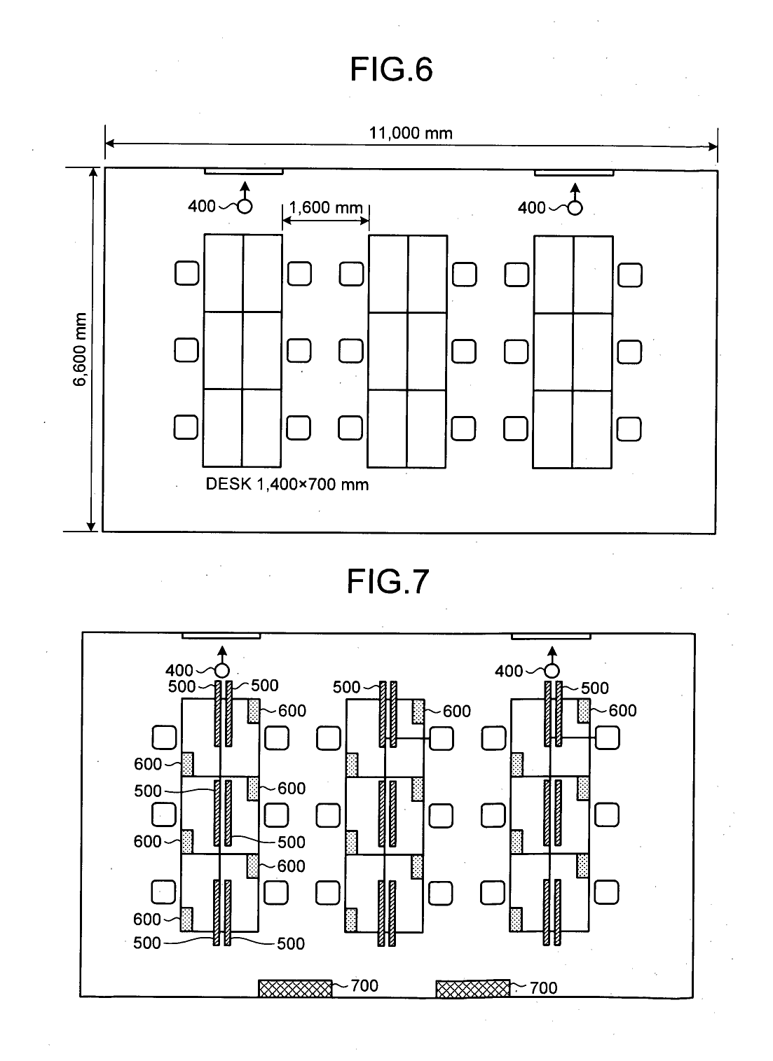

Referring back to FIG. 2, the monitoring cameras 400, which image the inside of the room serving as the control target area, are installed in the vicinity of the upper portion or the like of the room serving as the control target area. FIG. 6 is a schematic diagram illustrating an example of an installation condition of the monitoring cameras 400. In the example of FIG. 6, the monitoring cameras 400 are installed at two places near the doors of the room. The installation, however, is not limited to the example. The monitoring cameras 400 image the inside of the room serving as the control target area and transmit the imaged images (imaged video pictures) to the positioning server apparatus 100.

Referring back to FIG. 2, in the embodiment, a lighting system, a power strip system, and an air-conditioning system are the power control targets. The LED-lighting appliances 500 included in the lighting system, the power strips 600 included in the power strip system, and the air-conditioners 700 included in the air-conditioning system are the power control targets.

The LED-lighting appliances 500, the power strips 600, and the air-conditioners 700 are installed in the room serving as the control target area. FIG. 7 illustrates an example of an installation condition of the LED-lighting appliances 500, the power strips 600, and the air-conditioners 700.

As illustrated in FIG. 7, one group is formed with six desks and three groups are provided in the room. One LED-lighting appliance 500 and one power strip 600 are provided for each desk. One air-conditioner 700 is provided for each two groups at the position therebetween. The arrangement of the LED-lighting appliances 500, the power strips 600, and the air-conditioners 700 is an example, and not limited to the example illustrated in FIG. 7.

Summation information of total power of the room in the embodiment can be grasped by a system power measurement instrument installed outside the room, which is not illustrated in FIG. 7.

In the room, 18 employees perform respective specific tasks and the two doors allow them to get in and out of the room. In the embodiment, the layout, the appliances, and the number of users and the like are limited. The embodiment, however, is applicable to various layouts and various appliances. In addition, the embodiment is extendable and widely applicable to arbitrariness in scalability of a space size and the number of users, and arbitrariness in variation of user attribute and type of engaged task in terms of individuals or groups. The embodiment is not limited to the indoor space as illustrated in FIGS. 6 and 7, and is also applicable to an outdoor space or the like.

The positioning server apparatus 100 and the control server apparatus 200 of the embodiment are installed outside the room illustrated in FIGS. 6 and 7. In the embodiment, the positioning server apparatus 100 and the control server apparatus 200 are excluded from the power control targets. However, it is also possible to include them in the power control targets.

In the embodiment, Wi-Fi access points included in the communication network system and network appliances such as switching hubs and routers are excluded from the power control targets. However, it is also possible to include them in the power control targets.

An amount of power consumed by the network appliances can be calculated by subtracting the sum of power consumption of the LED-lighting appliances 500, the air-conditioners 700, and the power strips 600 from the sum of power consumption measured by the system power measurement instrument.

Each of the LED-lighting appliances 500, the power strips 600, and the air-conditioners 700 is remotely controlled by the control server apparatus 200 through the network.

That is, a lighting range and an illuminance of the LED-lighting appliance 500 are remotely controlled by the control server apparatus 200. Specifically, the LED-lighting appliance 500 is provided with an individually remote-controllable on-off switch and the on-off control is performed by the control server apparatus 200 in a wireless control scheme using Wi-Fi. The LED-lighting appliance 500 uses an LED lighting with a dimming function taking low power consumption into consideration and the dimming function is remote-controllable through Wi-Fi.

The lighting system is not limited to the LED-lighting appliance 500. For example, an incandescent lamp and a fluorescent lamp can be used.

Turning on or off of the power source of the air-conditioner 700 is remotely controlled by the control server apparatus 200. That is, the air-conditioner 700 is individually remote-controllable. A direction of wind and an air supply intensity are control targets in addition to the tuning on and off of the air-conditioner 700. In the embodiment, humidity and temperature of supply air are not controlled. However, not limited to this, it is possible to include the humidity and the temperature in the control targets.

The power strip 600 includes a plurality of outlets. Turning on or off of the supply of the power source to each outlet is remotely controlled by the control server apparatus 200. That is, the power strip 600 is provided with an individually remote-controllable on-off switch for each outlet. The power strip 600 is a communication power strip that communicates with the control server apparatus 200. The on-off control is performed by the control server apparatus 200 in a wireless control scheme using Wi-Fi. The number of outlets included in the power strip 600 may be any number. For example, the power strip having four outlets can be used.

As illustrated in FIG. 7, one power strip 600 is provided for each desk. Electrical appliances (not illustrated), specifically, a desktop personal computer (PC), a display, and chargers charging the respective batteries of a notebook PC, a printer, and the smartphone 300, are connectable to the power strip 600.

In the embodiment, a power source of the display, which is an important appliance in terms of a facing relation with a human, is connected to the outlet of the power strip 600. The turning on or off of the power supplied to the outlet for the display is controllable by the control server apparatus 200.

When the main body of the desktop PC and the printer are connected to the power strip 600, the turning on or off of power supplied to the outlet for them cannot be controlled by the control server apparatus 200 due to their structures. Because of this, the main body of the desktop is controlled for power saving by installing software that can cause the PC to proceed to a power saving mode or a shutdown through the network. Recovery from the power saving mode or the shutdown is done through manual operation by a user himself.

When the charger charging the battery of the smartphone 300 and the notebook PC to be charged are connected to the power strip 600, the outlets for them are consistently turned on taking user-friendliness into consideration. Appliances connected to the outlet of the power strip 600 are not limited to those described above.

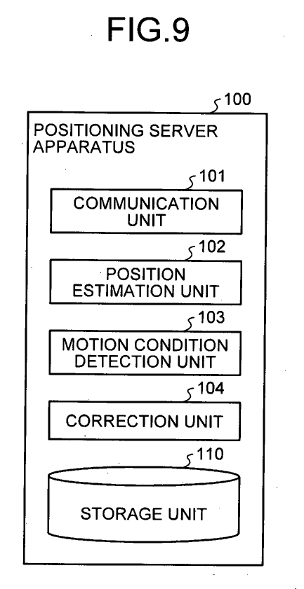

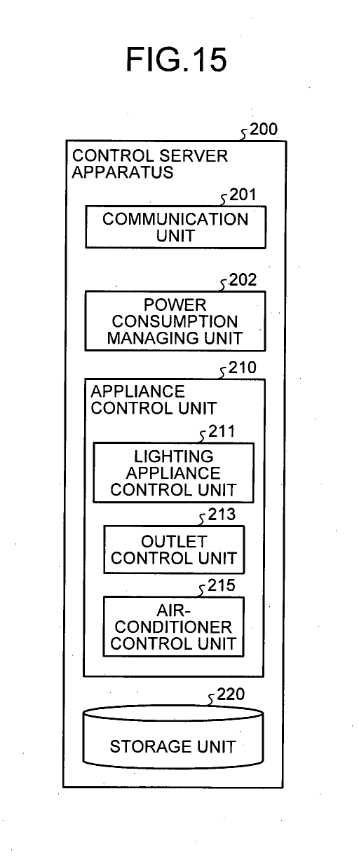

The power strip 600 has a function to measure the power consumed by the electrical appliances connected to the outlet and to transmit the power information, which is the measurement result, to the control server apparatus 200, for each outlet. For example, the power strip 600 measures, for each outlet, the power consumption of the electrical appliance connected to the outlet in accordance with a request from the control server apparatus 200 and returns the power information, which is the measurement result, to the control server apparatus 200 as the response to the request. The control server apparatus 200 collects the power information from the respective power strips 600 and uses the collected power information for managing the power consumption of the electrical appliances in a power consumption managing unit 202 (refer to FIG. 15), which is described later. The control server apparatus 200 transmits, to the positioning server apparatus 100 through the network, the power information of the electrical appliance used for correcting the position of the employee by a correction unit 104 (refer to FIG. 9), which is described later, of the positioning server apparatus 100 out of the collected power information.

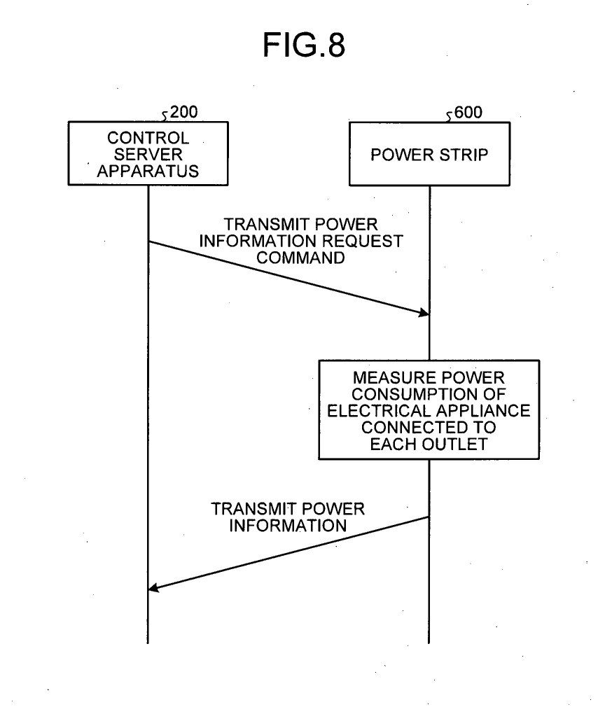

FIG. 8 is a schematic diagram explaining an example of a method in which the control server apparatus 200 collects the power information from the power strip 600. First, the control server apparatus 200 transmits a power information request command to the power strip 600. The power strip 600, which has received the power information request command from the control server apparatus 200, measures the power consumption of the electrical appliances connected to the respective outlets in accordance with the power information request command and transmits the power information serving as the measurement result to the control server apparatus 200 as the response to the power information request command. The collection of the power information thus performed by the control server apparatus 200 is repeated every predetermined period. In the collection, it is preferable that the control server apparatus 200 acquire the power information used for correcting the position of the employee at a period shorter than that for collecting the power information of the other electrical appliances. For example, the control server apparatus 200 acquires the power information of the electrical appliance used for correcting the position of the employee at a period of one second and the power information of the other appliances at a period of ten seconds. When the electrical appliance used for correcting the position of the employee and the other electrical appliances are connected to the identical power strip 600, information assigning the outlet from which the power is to be measured, is included in the power information request command. When only the power information of the electrical appliance used for correcting the position of the employee is acquired, the power information request command assigning the outlet to which the electrical appliance used for correcting the position of the employee is transmitted from the control server apparatus 200 to the power strip 600, while when the power information is also acquired from the other electrical appliances, the power information request command assigning all of the outlets is transmitted from the control server apparatus 200 to the power strip 600.

In the example illustrated in FIG. 8, the control server apparatus 200 transmits the power information request command to each of the power strips 600 and receives the power information from each of the power strips 600. When the power strips 600 are connected to a parent device, the control server apparatus 200 may transmit the power information request command to the parent device and receive the power information from the parent device. In the example illustrated in FIG. 8, the power strip 600 measures the power consumption of the electrical appliances connected to the outlet in accordance with the power information request command from the control server apparatus 200 and returns the power information to the control server apparatus 200. The power strip 600 may actively measure the power consumption of the electrical appliances and transmit the power information to the control server apparatus 200.

Referring back to FIG. 2, the positioning server apparatus 100 receives the detection data of the respective sensors, detects the position and the motion condition of the employee who wears the respective sensors and transmits the detection result data indicating the position and the motion condition to the control server apparatus 200.

FIG. 9 is a block diagram illustrating a functional structure of the positioning server apparatus 100. As illustrated in FIG. 9, the positioning server apparatus 100 mainly includes a communication unit 101, a position estimation unit 102, a motion condition detection unit 103, the correction unit 104, and a storage unit 110.

The storage unit 110 is a storage medium such as a hard disk drive device (HDD) or a memory and stores therein various types of information necessary for processing by the positioning server apparatus 100 such as map data of the room serving as the control target area and the positional information indicating the positions of the respective electrical appliances arranged in the room serving as the control target area. The storage unit 110 has the function as the storage unit 40 of the positioning apparatus 1 illustrated in FIG. 1.

The communication unit 101 receives every constant time interval the detection data from each of the acceleration sensor, the angular velocity sensor, and the geomagnetic sensor mounted on the smartphone 300 or each of the acceleration sensor, the angular velocity sensor, and the geomagnetic sensor of the sensor group 301, which is separately provided from the smartphone 300. That is, the communication unit 101 receives the acceleration vector from the acceleration sensor, the angular velocity vector from the angular velocity sensor, and the magnetic direction vector from the geomagnetic sensor.

The communication unit 101 receives the imaged images from the monitoring cameras 400. The communication unit 101 receives the power information of the electrical appliance used for correcting the position of the employee from the control server apparatus 200. That is, the communication unit 101 has the function as the acquisition unit 10 of the positioning apparatus 1 illustrated in FIG. 1. The communication unit 101 transmits the detection result data indicating the motion condition such as the position, direction, and posture of the employee, which is described later, to the control server apparatus 200.

When it is detected by the imaged image from the monitoring camera 400 that the employee enters the room from the door, the position estimation unit 102 analyzes the detection data received from the smartphone 300 attached to the entering employee, obtains a relative movement vector from a reference position of the employee (e.g., the position of the door in the room), checks the obtained relative movement vector against the map data stored in the storage unit 110, and estimates the position of the employee in the room with an accuracy of a human shoulder width or a human stride. That is, the position estimation unit 102 has the function as the estimation unit 20 of the positioning apparatus 1 illustrated in FIG. 1. Details of a technique for estimating the position of the employee by the position estimation unit 102 are described later.

The motion condition detection unit 103 analyzes the received detection data and detects the motion condition of the employee. In the embodiment, the motion condition detection unit 103 detects whether the employee is in a stationary condition or in a walking condition as the motion condition. When the motion condition is the stationary condition, the motion condition detection unit 103 detects a direction of the employee with respect to the appliance in the control target area and the motion condition whether the posture of the employee is a standing condition or a sitting condition on the basis of the detection data.

That is, when it is detected with the imaged image from the monitoring camera 400 that the employee enters the room from the door, the motion condition detection unit 103 sequentially determines whether the motion condition of the employee is the walking condition or the stationary condition using each pieces of time-series data of the acceleration vector and the angular velocity vector out of the detection data sequentially received from the acceleration sensor, the angular velocity sensor, and the geomagnetic sensor of the smartphone 300 attached to the employee who enters the room, or each of the acceleration sensor, the angular velocity sensor, and the geomagnetic sensor of the sensor group 301, which is separately provided from the smartphone 300. The technique for determining whether the motion condition of the employee is the walking condition using the acceleration vector and the angular velocity vector can be achieved by the processing performed by a dead reckoning apparatus disclosed in Japanese Patent No. 4243684, for example. When it is determined by the technique that the employee is not in the walking condition, the motion condition detection unit 103 determines that the employee is in the stationary condition. More specifically, the motion condition detection unit 103 can detect the motion condition of the employee as described below in the same manner as the processing by the dead reckoning apparatus disclosed in Japanese Patent No. 4243684.

That is, the motion condition detection unit 103 obtains a gravitational acceleration vector from the acceleration vector received from the acceleration sensor and the angular velocity vector received from the angular velocity sensor, subtracts the gravitational acceleration vector from the acceleration vector to remove the acceleration in the vertical direction, thereby obtaining the time-series data of the residual acceleration components. The motion condition detection unit 103 performs a principal component analysis on the time-series data of the residual acceleration components and obtains the direction of movement of the walking motion. The motion condition detection unit 103 searches a pair of an upper peak and a lower peak of the acceleration component in the vertical direction and a pair of the upper peak and the lower peak of the acceleration component in the direction of movement. Then, the motion condition detection unit 103 calculates a gradient of the acceleration component in the direction of movement.

Subsequently, the motion condition detection unit 103 determines whether the gradient of the acceleration component in the direction of movement at the detection time of the lower peak to which the acceleration component in the vertical direction changes from the upper peak is equal to or larger than a predetermined value, and when the gradient is equal to or larger than the predetermined value, the motion condition detection unit 103 determines that the motion condition of the employee is the walking condition.

In the processing, when no pair of the upper peak and the lower peak of the acceleration component in the vertical direction is found, no pair of the upper peak and the lower peak of the acceleration component in the direction of movement is found, or the gradient of the acceleration component in the direction of movement at the detection time of the lower peak to which the acceleration component in the vertical direction changes from the upper peak is smaller than the predetermined value, the motion condition detection unit 103 determines that the motion condition of the employee is the stationary condition.

When it is determined that the employee is in the stationary condition, the position estimation unit 102 obtains the relative movement vector from a reference position, which is the position of the door, to the position at which it is determined that the employee is in the stationary condition using the acceleration vector, the angular velocity vector, and the magnetic direction vector. As the technique for calculating the relative movement vector using the acceleration vector, the angular velocity vector, and the magnetic direction vector, the technique disclosed in the processing of the dead reckoning apparatus of Patent Literature 1 (Japanese Patent Application Laid-open No. 2011-47650) can be used, for example.

More specifically, the position estimation unit 102 can obtain the relative movement vector as described below in the same manner as the processing by the dead reckoning apparatus of Patent Literature 1 (Japanese Patent Application Laid-open No. 2011-47950).

That is, the position estimation unit 102 obtains a gravitational direction vector from the acceleration vector received from the acceleration sensor and the angular velocity vector received from the angular velocity sensor, and calculates a posture angle of a human as a moving direction from the gravitational direction vector, and the angular velocity vector or the magnetic direction vector received from the geomagnetic sensor. The position estimation unit 102 obtains the gravitational acceleration vector from the acceleration vector and the angular velocity vector, and calculates the acceleration vector produced by the walking motion from the gravitational acceleration vector and the acceleration vector. The position estimation unit 102 analyzes and detects the walking motion from the gravitational acceleration vector and the acceleration vector produced by the walking motion, measures a size of the walking motion on the basis of the detection result and the gravitational acceleration vector and the acceleration vector produced by the walking motion, and determines the measurement result as the stride. The position estimation unit 102 obtains the relative movement vector from the reference position by accumulating the moving direction and the stride thus obtained. That is, the relative position to the reference position of the employee is identified in real time with an accuracy of a human shoulder width or a human stride, e.g., equal to or smaller than about 60 cm (more specifically, equal to or smaller than about 40 cm).

After the relative movement vector is calculated in this way, the position estimation unit 102 estimates the position of the employee after the movement (absolute position) in the room from the relative movement vector from the door and the map data of the room stored in the storage unit 110.

As a result, the position estimation unit 102 can estimate the position of the employee to a level of which desk arranged in the room the employee is at, thereby making it possible to estimate the position of the employee with an accuracy of a human shoulder width or a human stride, e.g., equal to or smaller than about 60 cm (more specifically, equal to or smaller than about 40 cm).

Such positional accuracy is not about the higher, the better. For example, assuming a case where two or more employees are having a conversation, it is a rare that they are having a conversation while contacting their bodies to each other, and thus they are apart from each other at a certain distance. In terms of accuracy, an accuracy corresponding to a human shoulder width or a human stride, and an accuracy corresponding to a length from the waist to the knee for determining whether standing or sitting are appropriate accuracies in the embodiment.

According to the human body measurement data published by the Ministry of Health, Labor and Welfare (Makiko Kouchi, Masaaki Mochimaru, Hiromu Iwasawa, Seiji Mitani, Anthropometric database for Japanese population 1997-98, 2000, Japanese Industrial Standards Center, National Institute of Advanced Industrial Science and Technology, Ministry of International Trade and Industry), data corresponding to shoulder widths of men and women of adolescents and seniors (shoulder biacromial breadth) is about 35 cm (34.8 cm) for senior women, which shows the smallest range of the average and is about 40 cm (39.7 cm) for adolescent men, which shows the highest range of the average. Likewise, the difference in length between waist and knee (symphysion height minus lateral femoral tuberosity height) is about 34 cm to about 38 cm. A stride of a human while moving is about 53 cm (50/95×10) where 95 steps is needed for 50 m walking. The position detection method of the embodiment can detect the position with an accuracy corresponding to a stride. The embodiment is based on that the accuracy equal to or smaller than 60 cm, preferably equal to or smaller than 40 cm, is appropriate from the data described above. The data, which is collected from Japanese, gives an indication of a reference to the accuracy. The values, however, are not limited to those.

When estimating the absolute position of the employee and the employee whose position is estimated is in the stationary condition on a seat in front of the desk, the motion condition detection unit 103 determines the direction (facing direction) of the employee with respect to the display from the direction of the magnetic direction vector received from the geomagnetic sensor. When the employee is in the stationary condition on the seat in front of the desk, the motion condition detection unit 103 determines the posture of the employee, i.e., whether in a standing condition or in a sitting condition, from the acceleration component in the vertical direction of the acceleration vector.

The determination of whether the standing condition or the sitting condition can be made by obtaining the gravitational acceleration vector from the acceleration vector received from the acceleration sensor and the angular velocity vector received from the angular velocity sensor, and obtaining the acceleration component in the vertical direction in the same manner as the dead reckoning apparatus disclosed in Japanese Patent No. 4243684, for example. The motion condition detection unit 103 can obtain the upper and the lower peaks of the acceleration component in the vertical direction in the same manner as the dead reckoning apparatus disclosed in Japanese Patent No. 4243684, for example.

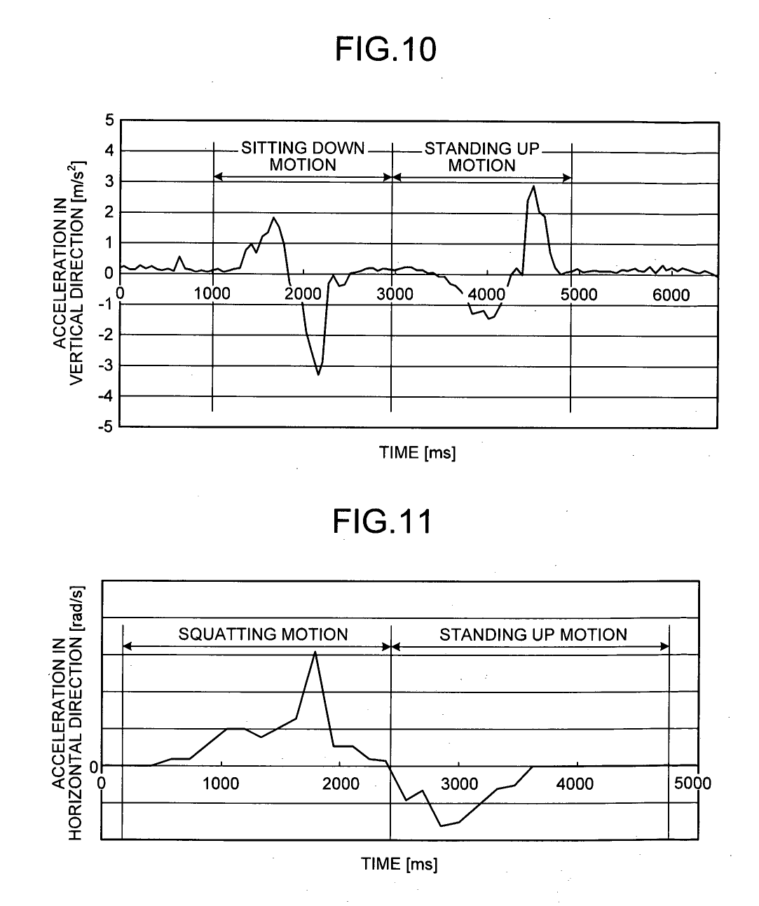

FIG. 10 is a schematic diagram illustrating a waveform of the acceleration component in the vertical direction when a sitting down motion and a standing up motion are performed. As illustrated in FIG. 10, an interval from the upper peak to the lower peak of the acceleration component in the vertical direction is around 0.5 seconds in the sitting down motion, whereas an interval from the lower peak to the upper peak of the acceleration component in the vertical direction is about 0.5 seconds in the standing up motion. The motion condition detection unit 103, thus, determines whether the employee is in the sitting condition or in the standing condition on the basis of the interval between the peaks. That is, when the interval from the upper peak to the lower peak of the acceleration component in the vertical direction is in a predetermined range from 0.5 seconds, the motion condition detection unit 103 determines that the motion condition of the employee is the sitting condition. When the interval from the lower peak to the upper peak of the acceleration component in the vertical direction is in a predetermined range from 0.5 seconds, the motion condition detection unit 103 determines that the motion condition of the employee is the standing condition.

The determination performed by the motion condition detection unit 103 whether the motion condition of the employee is the standing condition or the sitting condition means that the position of the employee in a height direction is detected with an accuracy of about equal to or smaller than 50 cm (more specifically, equal to or smaller than 40 cm).

Furthermore, when the employee wears the smartphone 300 mounted with the information appliances detecting human motions such as the acceleration sensor, the angular velocity sensor, and the geomagnetic sensor at the waist, and additionally the small head-set sensor group 301 including the acceleration sensor, the angular velocity sensor, and the geomagnetic sensor on the head as illustrated in FIG. 4, the motion condition detection unit 103 can further detect the following postures and motions of the employee.

FIG. 11 is a schematic diagram illustrating a waveform of the angular velocity component in the horizontal direction when a squatting motion and a standing up motion are performed. Although a waveform similar to that in the sitting down motion and the standing up motion illustrated in FIG. 10 is detected from acceleration data of the acceleration sensor, it is difficult to distinguish the squatting motion from the standing up motion on the basis of the acceleration data only.

Therefore, the motion condition detection unit 103 distinguishes the squatting motion to the standing up motion by determining whether a time-dependent change in angular velocity data in the horizontal direction received from the angular velocity sensor is the same as the waveform illustrated in FIG. 11 together with the technique for distinguishing the sitting down motion from the standing up motion on the basis of the waveform of FIG. 10.

Specifically, the motion condition detection unit 103 first determines whether the interval from the upper peak to the lower peak of the acceleration component in the vertical direction based on the acceleration vector received from the acceleration sensor is in a predetermined range from 0.5 seconds.

Then, in the case that the interval from the upper peak to the lower peak of the acceleration component in the vertical direction is in the predetermined range from 0.5 seconds, the motion condition detection unit 103 determines that the motion of the employee is the squatting motion when the angular velocity component in the horizontal direction of the angular velocity vector received from the angular velocity sensor changes like the waveform illustrated in FIG. 11, in which the angular velocity component gradually increases from zero (0) and thereafter leaps and reaches the upper peak, and then rapidly decreases from the upper peak and thereafter gradually returns to zero (0), and this period of time is about two seconds.

The motion condition detection unit 103 determines whether the interval from the lower peak to the upper peak of the acceleration component in the vertical direction is in a predetermined range from 0.5 seconds. Then, in the case that the interval from the lower peak to the upper peak of the acceleration component in the vertical direction is in the predetermined range from 0.5 seconds, the motion condition detection unit 103 determines that the motion of the employee is the standing up motion when the angular velocity component in the horizontal direction of the angular velocity vector received from the angular velocity sensor changes like the waveform illustrated in FIG. 11, in which the angular velocity component reaches the lower peak in a step-by-step manner from zero (0) and thereafter gradually returns to zero (0) from the lower peak and this period of time is about 1.5 seconds.

As the angular velocity vector used for the determination of the squatting motion and the standing up motion by the motion condition detection unit 103, it is preferable to use the angular velocity vector received from the angular velocity sensor attached to the head. Because the angular velocity component in the horizontal direction based on the angular velocity vector from the angular velocity sensor attached to the head notably shows the waveform illustrated in FIG. 11 in the squatting motion and the standing up motion.

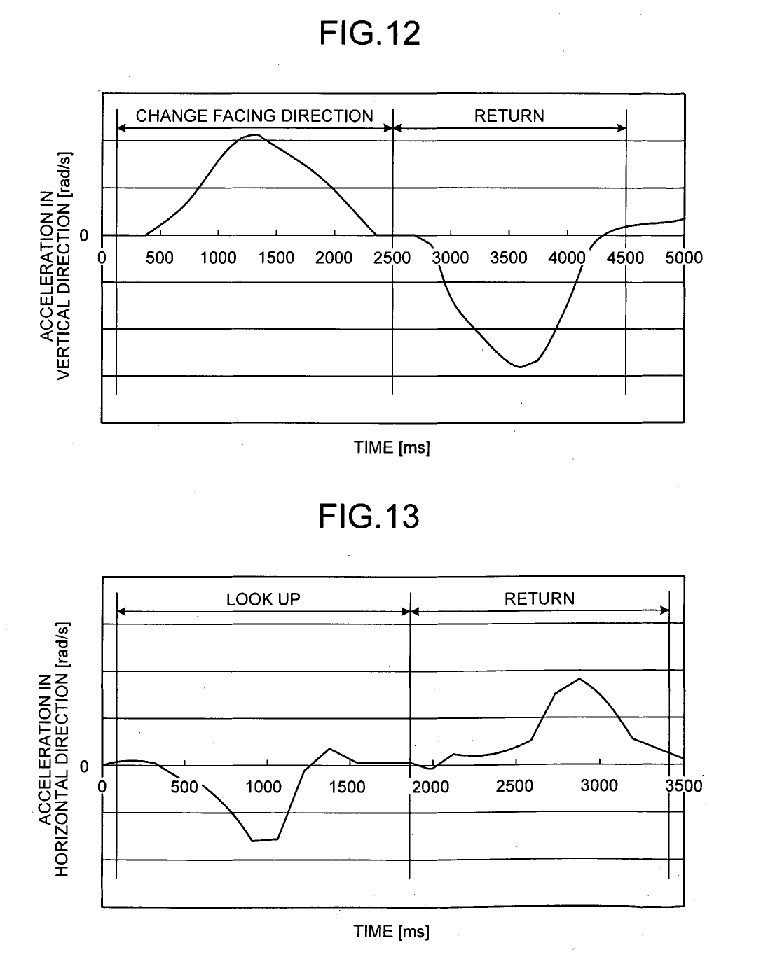

FIG. 12 is a schematic diagram illustrating a waveform of the angular velocity component in the vertical direction when the employee performs a motion of changing the direction by about 90 degrees in the stationary condition. When the angular velocity component in the vertical direction is positive, the motion is that of changing the facing direction to the right side while when the angular velocity component in the vertical direction is negative, the motion is that of changing the direction to the left side.

The motion condition detection unit 103 determines that the motion is that of changing the direction to the right when a time-dependent change in angular velocity component in the vertical direction of the angular velocity vector received from the angular velocity sensor is like the waveform illustrated in FIG. 12, in which the angular velocity component reaches the upper peak gradually from zero (0) and thereafter gradually returns to zero (0) and this period of time is about three seconds.

The motion condition detection unit 103 determines that the motion is that of changing the direction to the left when a time-dependent change in angular velocity component in the vertical direction is like the waveform illustrated in FIG. 12, in which the angular velocity component reaches the lower peak gradually from zero (0) and thereafter gradually returns to zero (0) and this period of time is about 1.5 seconds.

The motion condition detection unit 103 determines that the motion is that of changing the facing direction of the whole body to the right or the left when angular velocity components in the vertical direction of the angular velocity vectors received from the both of the angular velocity sensors at the head and of the smartphone 300 at the waist indicate a time-dependent change similar to the waveform of FIG. 12 on the basis of the determination described above.

The motion condition detection unit 103 determines that the motion is that of changing only the direction of the head to the right or the left when the angular velocity component in the vertical direction of the angular velocity vector received from the angular velocity sensor at the head shows a time-dependent change similar to the waveform of FIG. 12, and the angular velocity component in the vertical direction of the angular velocity vector received from the angular velocity sensor of the smartphone 300 at the waist shows a time-dependent change totally difference from the waveform of FIG. 12. An example of such a motion is a postural motion of the employee who has a communication with an employee next to the employee while sitting.

FIG. 13 is a schematic diagram illustrating a waveform of the angular velocity component in the horizontal direction of the angular velocity vector received from the angular velocity sensor at the head when the employee changes the direction of the eyes in an upward direction away from the display in the sitting condition.

A case is assumed where the position estimation unit 102 estimates that the absolute position of the employee is in front of a desk and the motion condition detection unit 103 detects that the employee who is in front of the desk is in the sitting condition. In such a case, the motion condition detection unit 103 determines that the motion is that of changing the direction of the eyes in the upward direction away from the display in the sitting condition (motion for looking up) when the angular velocity component in the horizontal direction of the angular velocity vector received from the angular velocity sensor at the head of the employee changes like the waveform illustrated in FIG. 13, in which the angular velocity component reaches the lower peak gradually from zero (0) and thereafter rapidly returns to zero (0) and this period of time is about one second. Furthermore, the motion condition detection unit 103 determines the motion of returning the direction of the eyes to the display from the state where the direction of the eyes is changed in the upward direction away from the display in the sitting condition when the angular velocity component in the horizontal direction changes as the waveform illustrated in FIG. 13, in which the velocity component increases gradually from zero (0) and reaches the upper peak and thereafter gradually returns to zero (0) and this period of time is about 1.5 seconds.

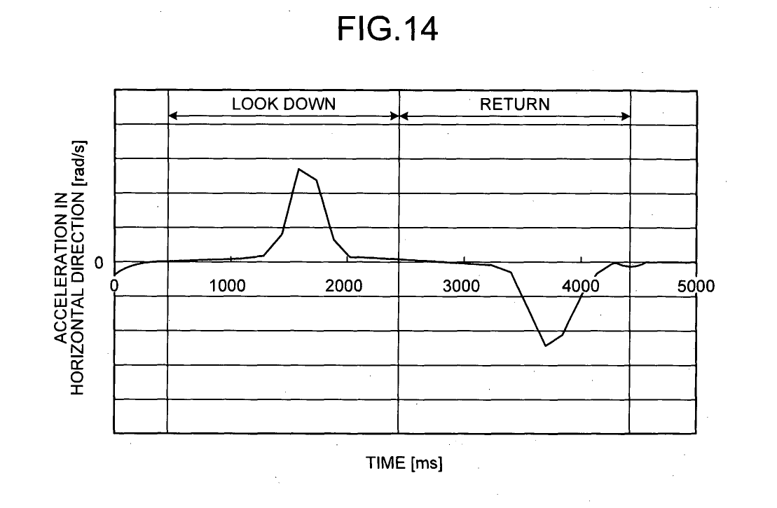

FIG. 14 is a schematic diagram illustrating a waveform of the angular velocity component in the horizontal direction of the angular velocity vector received from the angular velocity sensor at the head when the employee changes the direction of the eyes in a downward direction away from the display in the sitting condition.

A case is assumed where the position estimation unit 102 identifies that the absolute position of the employee is in front of a desk and the motion condition detection unit 103 detects that the employee who is in front of the desk is in the sitting condition. In such a case, the motion condition detection unit 103 determines that the motion is that of changing the direction of the eyes in the downward direction away from the display in the sitting condition (motion for looking down) when the angular velocity component in the horizontal direction of the angular velocity vector received from the angular velocity sensor at the head of the employee changes like the waveform illustrated in FIG. 14, in which the angular velocity component reaches the upper peak rapidly from zero (0) and thereafter rapidly returns to zero (0) and this period of time is about 0.5 seconds.

Furthermore, the motion condition detection unit 103 determines that the motion is that of returning the direction of the eyes to the display from the condition where the direction of the eyes is changed in the downward direction away from the display in the sitting condition when the angular velocity component in the horizontal direction changes like the waveform illustrated in FIG. 14, in which the angular velocity component decreases rapidly from zero (0) and reaches the lower peak and thereafter rapidly returns to zero (0) and this period of time is about one second.

In this way, the motion condition detection unit 103 can determine by the technique describe above the postures and motions that the employee in an office can routinely do such as walking (standing condition), standing up (stationary condition), sitting on a chair, squatting during work, changing the direction (facing direction) in the sitting condition or in the standing condition, looking up in the sitting condition or in the standing condition, and looking down in the sitting condition or in the standing condition.

When the technique of the dead reckoning apparatus disclosed in Japanese Patent No. 4243684 is used, moving up and down of a human in an elevator is also determined using the acceleration component in the vertical direction as disclosed in Japanese Patent No. 4243684.

In the embodiment, the motion condition detection unit 103 can determine whether the motion is the standing up motion or the sitting down motion with a high accuracy using a function of a map matching apparatus disclosed in Japanese Patent Application Laid-open No. 2009-14713 when the acceleration component in the vertical direction is detected as the waveform illustrated in FIG. 10 at a place where no elevator is provided, unlike the case where the moving up and down of a human in the elevator is determined using the dead reckoning apparatus.

In the embodiment, the motion condition, the relative movement vector from the reference position, the posture (standing condition or sitting condition) of the employee are detected using the technique similar to the dead reckoning apparatus disclosed in Japanese Patent No. 4243684 and Patent Literature 1 (Japanese Patent Application Laid-open No. 2011-47950). The detection technique, however, is not limited to these techniques. In the description described above, the position of the employee is identified when it is determined that the motion condition of the employee is the stationary condition. The position of the employee may be sequentially identified also when the motion condition of the employee is the walking condition, in the same manner as described above.

The correction unit 104 corrects the position of the employee in the room estimated by the position estimation unit 102 on the basis of the power information received by the communication unit 101 from the control server apparatus 200 and the positional information of the electrical appliance stored in the storage unit 110. That is, the correction unit 104 has the function as the correction unit 30 of the positioning apparatus 1 illustrated in FIG. 1.

The power information indicating the power consumption of the electrical appliance is an index for determining whether the employee is present at the position of the electrical appliance. That is, because operation of the electrical appliance by the employee causes a change in power consumption, the change in power information makes it possible to determine that the electrical appliance is operated by the employee, i.e., the employee is present at a position where the employee can operate the electrical appliance. In the embodiment, the power information indicating the power consumed by the electrical appliance a user of which can be identified, e.g., the electrical appliance the employee exclusively uses (hereinafter, described as an exclusive appliance), is sent from the control server apparatus 200 to the positioning server apparatus 100, and the correction unit 104 of the positioning server apparatus 100 corrects the position of the employee estimated by the position estimation unit 102 using this power information.

For example, the correction unit 104 refers to the positional information of the electrical appliances stored in the storage unit 110 and determines whether the exclusive appliance of the employee (e.g., a desktop PC, a notebook PC, or a charger) is disposed in a predetermined range from the position of the employee estimated by the position estimation unit 102. The correction unit 104 determines whether an amount of change in power consumption of the exclusive appliance exceeds a predetermined threshold on the basis of the power information of the exclusive appliance when the exclusive appliance is disposed in the predetermined range from the estimated position of the employee. When the amount of change in power consumption of the exclusive appliance exceeds the threshold, the correction unit 104 identifies the exclusive appliance as the electrical appliance the employee operates, and corrects the position of the employee estimated by the position estimation unit 102 to the position of the exclusive appliance.

As a method for identifying the exclusive appliance, information indicating a corresponding relation between the employee and the exclusive appliance is caused to be included in the positional information stored in the storage unit 110 or the information indicating the corresponding relation between the employee and the exclusive appliance is stored in the storage unit 110 as the data different from the positional information, for example, and the correction unit 104 identifies the exclusive appliance of the employee on the basis of the information indicating the corresponding relation between the employee and the exclusive appliance. Personal authentication information of the employee is transmitted from the smartphone 300 the employee carries to the positioning server apparatus 100 together with the detection data, for example.

In the example described above, the correction unit 104 corrects the position of the employee using the power information of the exclusive appliance. The correction, however, is not limited to the example. The correction unit 104 can also correct the position of the employee using the power information of electrical appliances other than the exclusive appliance. For example, when it is determined, on the basis of the power information of the other electrical appliances other than the exclusive appliance, that an amount of change in power consumption of a certain electrical appliance exceeds a threshold, the correction unit 104 may correct the position of the employee who is the closest to the position of the electrical appliance, out of a plurality of positions of the employee estimated by the position estimation unit 102, to the position of the electrical appliance.

The positional information used by the correction unit 104 for correcting the position of the employee indicates the position of each electrical appliance disposed in the room. The position of the electrical appliance described herein, however, does not always mean the position of the main body unit of the electrical appliance. For example, when the main body unit of the electrical appliance and the operating unit operated by the employee for using the electrical appliance are installed spaced apart from each other, the position of the electrical appliance indicated by the positional information is the position of the operating unit of the electrical appliance. When the electrical appliance operates on the basis of a detection result of a human sensor or an object detection sensor, the position of the electrical appliance indicated by the positional information is the position of the detection target area of the human sensor or the object detection sensor.

The correction unit 104 may further correct the position of the employee estimated by the position estimation unit 102 on the basis of the imaged image from the monitoring camera 400 in addition to the correction of the position of the employee using the power information of the electrical appliance. The correction unit 104 may further correct the position of the employee estimated by the position estimation unit 102 by the function of the map matching apparatus disclosed in Japanese Patent Application Laid-open No. 2009-14713 using the map data stored in the storage unit 110, for example. The correction unit 104 may correct not only the position of the employee estimated by the position estimation unit 102 but also the motion conditions (facing direction and posture) detected by the motion condition detection unit 103 by image analysis on the imaged image from the monitoring camera 400 or the like.

As the method for correcting the position of the employee estimated by the position estimation unit 102, other various techniques such as short distance wireless communication including RFID and Bluetooth (registered trademark), and optical communication may be used. The use of such techniques only for correcting the position of the employee estimated by the position estimation unit 102 requires an extensive system, thereby causing a problem of an increase in cost and the like. In the embodiment, the position of the employee estimated by the position estimation unit 102 is corrected using the power information collected for managing the power consumption of the electrical appliances, thereby making it possible to measure the position of the employee with a high accuracy employing a simple structure.

As techniques that can detect the positions of humans, other techniques are known besides the above-described method performed by the positioning server apparatus 100 on the basis of the detection data of the acceleration sensor, the angular velocity sensor, and the geomagnetic sensor. For example, the following techniques are known: a room entering and leaving management using IC cards or the like, detection of humans by a human sensor, a method using a wireless LAN, a method using an indoor GPS (Indoor Messaging System (IMES)), a method in which an imaged image of a camera is image processed, a method using active RFID, and a method using visible light communication.

The room entering and leaving management using IC cards or the like can identify individuals but the positioning accuracy is extremely low because the whole area is the management target. Therefore, it is possible to know who is present in the area, but it is impossible to grasp activity conditions of humans in the area.

The detection of humans by the human sensor can achieve a positioning accuracy of about 1 to 2 m, which is a detection range of the human sensor, but cannot identify individuals. In addition, a number of human sensors need to be arranged dispersed in the area to grasp the activity conditions of humans in the area.

The method using the wireless LAN measures distances between a single wireless LAN terminal a human has and a plurality of LAN access points installed in the area and identifies the position of the human in the area using a principle of triangulation. This method can identify individuals but has large environmental dependence in positioning accuracy. In general, the positioning accuracy, which is equal to or larger than 3 m, is relatively low.

In the method using the indoor GPS, a dedicated transmitter that transmits radio waves having the same frequency range as the GPS satellites is installed indoors and the transmitter transmits a signal in which the positional information is embedded in a part used for the GPS satellites to transmit time information. A receiving terminal held by an indoor human receives the signal and the indoor position of the human is identified. This method can identify individuals but the position accuracy, which is about 3 to 5 m, is relatively low. It is necessary to install the dedicated transmitter, thereby increasing an installation cost.

The method in which the imaged image of the camera is image processed achieves a relatively high positioning accuracy of about several tens of centimeters but has a difficulty in identifying individuals. The positioning server apparatus 100 of the embodiment thus uses the imaged image of the monitoring camera 400 only in a case where the position, direction, and posture of the employee are corrected.

In the method using the active RFID, a human has an RFID tag including a built-in battery, and the position of the human is identified by reading the information of the FRID tag by a tag reader. This method can identify individuals but has large environmental dependence in positioning accuracy. In general, the positioning accuracy, which is equal to or larger than 3 m, is relatively low.

The method using the visual light communication can identify individuals and achieve a relatively high positioning accuracy of about several tens of centimeters but cannot detect humans at a place where visual light is blocked and has a difficulty in maintaining stability of the detection accuracy because there are many noise sources and interference sources such as natural light and other forms of visible light.

Unlike these techniques, the method performed by the positioning server apparatus 100 of the embodiment can identify individuals, achieve a high positioning accuracy of a human shoulder width or a human stride, and further detect the motion conditions of humans. Specifically, the method performed by the positioning server apparatus 100 of the embodiment can detect, as the human motion conditions, the postures and motions that the employees in an office can routinely do such as walking (standing condition), standing up (stationary condition), sitting on a chair, squatting during work, changing the direction (facing direction) in the sitting condition or in the standing condition, looking up in the sitting condition or in the standing condition, and looking down in the sitting condition or in the standing condition.

In the embodiment, the positioning server apparatus 100 detects the position and the motion condition of the employee in the office serving as the control target area by the method described above on the basis of the detection data of the acceleration sensors, the angular velocity sensors, and the geomagnetic sensors of the smartphone 300 and the sensor group 301. The method for detecting the position of the employee in the room serving as the control target area is not limited to the method performed by the positioning server apparatus 100. For example, the position of the employee may be detected by one of the other methods described above or a combination of them. The position of the employee may be detected by a combination of the method performed by the positioning server apparatus 100 and one or more than one of the other methods.

Next, details of the control server apparatus 200 are described. The control server apparatus 200 remotely controls each of the LED-lighting appliances 500, the power strips 600, and the air-conditioners 700 through the network that are installed in the room on the basis of the position and the motion information (direction and posture) of the employee in the room serving as the control target area.

FIG. 15 is a block diagram illustrating an example of a functional structure of the control server apparatus 200 of the embodiment. As illustrated in FIG. 15, the control server apparatus 200 of the embodiment mainly includes a communication unit 201, the power consumption managing unit 202, an appliance control unit 210, and a storage unit 220.

The storage unit 220, which is a storage medium such as an HDD or a memory, stores therein various types of information necessary for the processing by the control server apparatus 200 such as the positional information of the LED-lighting appliances 500, the power strips 600, and the air-conditioners 700 that serve as the control targets.

The communication unit 201 receives the detection result data indicating the position and the motion information (direction and posture) of the employee from the positioning server apparatus 100. The communication unit 201 receives the power information indicating the power consumption from the LED-lighting appliances 500, the electrical appliances connected to the power strips 600, and the air-conditioners 700. The communication unit 201 transmits the power information of the electrical appliance used for correcting the position of the employee by the correction unit 104 of the positioning server apparatus 100 out of the received power information to the positioning server apparatus 100 through the network. The communication unit 201 transmits control signals to perform power control on the LED-lighting appliances 500, the power strips 600, and the air-conditioners 700.

The power consumption managing unit 202 manages the power consumption of the LED-lighting appliances 500, the electrical appliances connected to the power strips 600, and the air-conditioners 700 on the basis of the power information received by the communication unit 201. The power consumption managing unit 202 can acquire not only the power consumption of each appliance serving as the control target but also the sum of the power consumption of each system from the system power measurement instrument described above, and grasp and manage a total amount of power consumption of the whole of the control target area. “Visualization” of the power consumption can be achieved by making it possible to display the information of the power consumption managed by the power consumption managing unit 202 on the display, for example.

The appliance control unit 210 includes a lighting appliance control unit 211, an outlet control unit 213, and an air-conditioner control unit 215. The lighting appliance control unit 211 controls the LED-lighting appliance 500 on the basis of the position and the motion information (direction and posture) of the employee in the room serving as the control target area. More specifically, the lighting appliance control unit 211 transmits, to the LED-lighting appliance 500 through the communication unit 201, a control signal setting the lighting range of the LED-lighting appliance 500 disposed in the vicinity of the position of the employee to be narrower than a predetermined range so as to set the illuminance to be higher than a predetermined threshold when the employee is in the sitting condition, for example. This control signal makes it possible, for the employee who is working in the sitting condition, to control the lighting range and the illuminance suitable for detailed work.

When the employee is in the standing condition, the lighting appliance control unit 211 transmits, to the LED-lighting appliance 500 through the communication unit 201, the control signal setting the lighting range to be wider than the predetermined range so as to set the illuminance to be lower than the predetermined threshold. This control signal makes it possible to control the lighting range and the illuminance such that the employee who is in the standing condition can overlook the whole of the room, for example.

The outlet control unit 213 controls turning on and off of the power source of the outlet of the power strip 600 on the basis of the position and the motion information (direction and posture) of the employee in the room serving as the control target. More specifically, the outlet control unit 213 transmits, to the display connected to the power strip 600 disposed in the vicinity of the position of the employee through the communication unit 201, a control signal turning on the switch of the outlet to which the display is connected in the power strip 600 when the employee is in the sitting condition and the direction with respect to the display is a frontward direction, for example.

When the employee is in the standing condition or the direction with respect to the display is a backward direction, the outlet control unit 213 transmits, to the display connected to the power strip 600 through the communication unit 201, a control signal turning off the switch of the outlet to which the display is connected in the power strip 600.

The reason why the power control is performed depending on the direction of the employee with respect to the display is that the display is an important appliance in terms of a facing relation with the employee, and when the direction is the frontward direction, it can be determined that the display is used. When the posture of the employee is the sitting condition, it can be determined that the display is used. In the embodiment, the power control is performed taking the actual use of the appliance into consideration in this way, thereby making it possible to perform more precise control, than a case where power control is performed simply on the basis of a distance from the appliance.

Furthermore, the outlet control unit 213 of the embodiment controls the power of the desktop PC main body and the display in coordination with the personal authentication information of the employee. The personal authentication information of the employee is sent to the positioning server apparatus 100 from the smartphone 300 the employee holds and transmitted to the control server apparatus 200 from the positioning server apparatus 100, for example. The control server apparatus 200 can perform the power control on the desktop PC main body and the display that the employee exclusively uses using the personal authentication information.

The air-conditioner control unit 215 controls turning on and off of the power source of the air-conditioner 700 on the basis of the position of the employee in the room serving as the control target area. More specifically, the air-conditioner control unit 215 transmits, through the communication unit 201, a control signal turning on the power source of the air-conditioner 700 provided for the group in which the seat at the position of the employee is present.

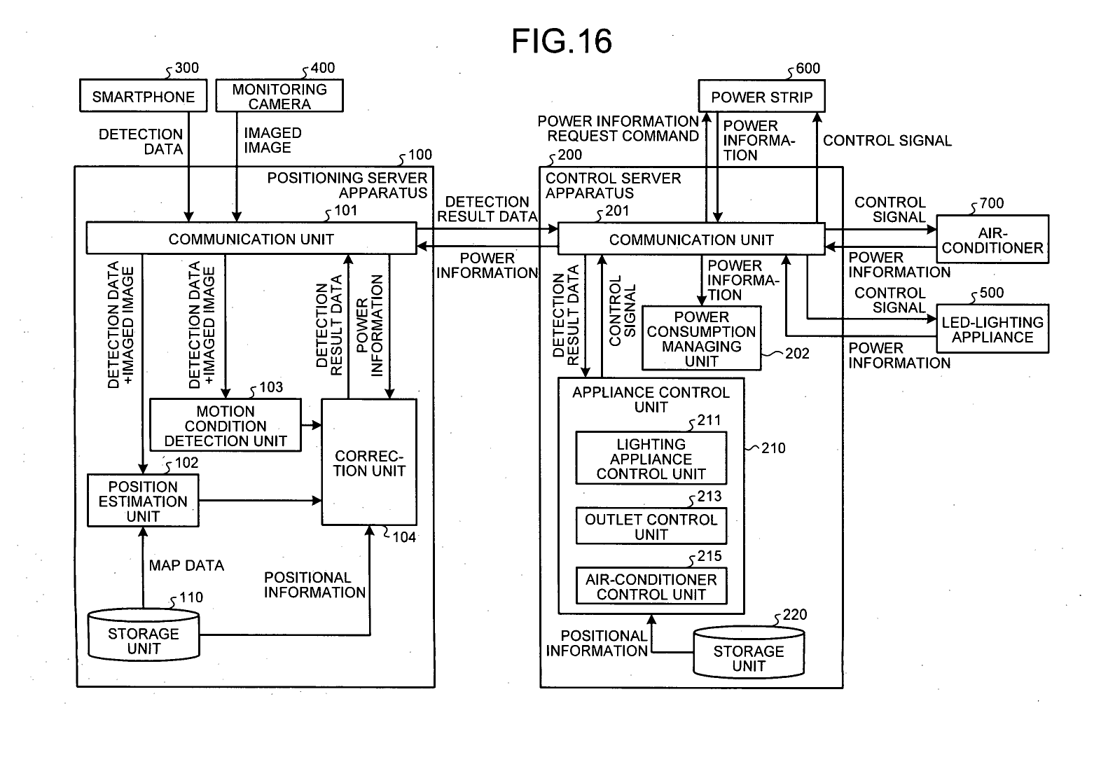

FIG. 16 is a schematic diagram explaining a flow of information handled in the appliance control system of the embodiment. The communication unit 101 of the positioning server apparatus 100 receives the detection data of the smartphone 300 and the imaged image of the monitoring camera 400. The detection data and the imaged image received by the communication unit 101 are passed to the position estimation unit 102 and the motion condition detection unit 103. The position estimation unit 102 estimates the position of the employee in the room on the basis of the detection data and the imaged image, and the map data stored in the storage unit 110. The motion condition detection unit 103 detects the motion condition of the employee on the basis of the detection data and the imaged image.

The communication unit 201 of the control server apparatus 200 transmits the power request command to the power strip 600 at a predetermined period and receives the power information from the power strip 600 as the response to the command. The communication unit 201 receives the power information from the LED-lighting appliance 500 and the air-conditioner 700 at a predetermined period. The power information received by the communication unit 201 is passed to the power consumption managing unit 202. The power consumption managing unit 202 manages the power consumption of the LED-lighting appliances 500, the electrical appliances connected to the power strips 600, and the air-conditioners 700 on the basis of the power information.

The power information used for correcting the position of the employee such as the power information of the exclusive appliance, out of the power information received by the communication unit 201, is transmitted to the positioning server apparatus 100 through the network. The communication unit 101 of the positioning server apparatus 100 receives the power information transmitted from the control server apparatus 200 through the network. The power information received by the communication unit 101 is passed to the correction unit 104. The correction unit 104 corrects the position of the employee estimated by the position estimation unit 102 on the basis of the power information and the positional information of the electrical appliance stored in the storage unit 110. The position of the employee corrected by the correction unit 104 and the motion condition detected by the motion condition detection unit 103 are transmitted to the control server apparatus 200 through the network from the communication unit 101 as the detection result data.

The communication unit 201 of the control server apparatus 200 receives the detection result data transmitted from the positioning server apparatus 100 through the network. The detection result data received by the communication unit 201 is passed to the appliance control unit 210. The lighting appliance control unit 211, the outlet control unit 213, and the air-conditioner control unit 215 of the appliance control unit 210 determine the control contents of the respective appliances on the basis of the detection result data, transmit the control signals to the respective appliances serving as the control targets through the communication unit 201, and control the respective appliances serving as the control targets.

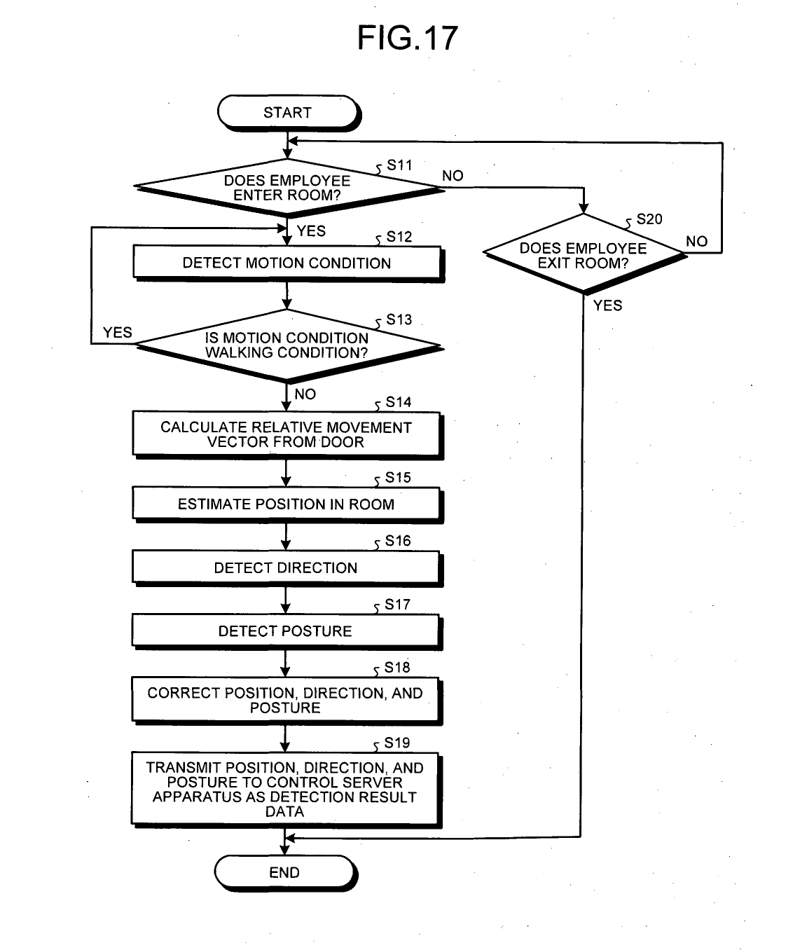

Next, the following describes detection processing by the positioning server apparatus 100 thus structured of the embodiment. FIG. 17 is a flowchart illustrating a procedure of the detection processing by the positioning server apparatus 100 of the embodiment. The detection processing according to the flowchart is executed for each of the smartphones 300.

The positioning server apparatus 100 receives the detection data (acceleration vector, angular velocity vector, and magnetic direction vector) from each of the acceleration sensor, the angular velocity sensor, and the geomagnetic sensor mounted on the smartphone 300 or the acceleration sensor, the angular velocity sensor, and the geomagnetic sensor that are provided separately from the smartphone 300 with constant intervals, the imaged images from the monitoring cameras 400, and the power information from the control server apparatus 200, in addition to the detection processing illustrated in the flowchart.

The positioning server apparatus 100 determines first whether the employee enters the room serving as the control target area with imaged image of the door opening or closing, for example (step S11). If the employee enters the room (Yes at step S11), the motion condition detection unit 103 detects the motion condition of the employee who enters the room using the technique described above (step S12). Then, the motion condition detection unit 103 determines whether the motion condition of the employee is the walking condition (step S13), and repeats the detection of the motion condition during the walking condition (Yes at step S13). If the employee does not enter the room (No at step S11), the motion condition detection unit 103 determines whether or not the employee exits the room (step S20), and repeats determination whether or not the employee enters the room (No at step S20).

If the motion condition of the employee is not the walking condition (No at step S13), the motion condition detection unit 103 determines that the motion condition of the employee is the stationary condition. The position estimation unit 102 calculates the relative movement vector from the door by the technique described above using the door as the reference position (step S14).

The position estimation unit 102 estimates the position of the employee who is in the stationary condition in the room on the basis of the map data of the room stored in the storage unit 110 and the relative movement vector from the door (step S15). As a result, the position estimation unit 102 can estimate the position of the employee to a level of which desk arranged in the room the employee is at, thereby estimating the position of the employee with an accuracy of a shoulder width of the employee (equal to or smaller than about 60 cm, more specifically, equal to or smaller than about 40 cm).

Then, the motion condition detection unit 103 further detects the direction (facing direction) of the employee with respect to the display as the motion condition of the employee who is in the stationary condition from the magnetic direction vector received from the geomagnetic sensor (step S16).

Then, the motion condition detection unit 103 detects whether the posture is the sitting condition or the standing condition as the motion condition of the employee by the technique described above (step S17). As a result, the motion condition detection unit 103 detects the position of the employee in the height direction with an accuracy of equal to or smaller than about 50 cm (more specifically, equal to or smaller than about 40 cm).

Furthermore, the motion condition detection unit 103 may detect, as the motion condition of the employee, each of whether it is the squatting motion or the standing up motion, whether it is the motion of changing the facing direction or the motion of returning the facing direction in the sitting condition, whether it is the motion of changing the direction of the eyes in the upward direction or the motion of returning the direction of the eyes in the sitting condition, and whether it is the motion of changing the direction of the eyes in the downward direction or the motion of returning the direction of the eyes in the sitting condition.

Then, the correction unit 104 determines whether it is necessary to correct the position of the employee estimated at step S15 on the basis of the power information and the positional information of the electrical appliance stored in the storage unit 110, and corrects the position if necessary. The correction unit 104 also corrects the direction of the employee detected at step S16 and the posture of the employee detected at step S17, if necessary (step S18).

The communication unit 101 transmits the position of the employee in the room, and the detected direction and the posture (when the correction is made, the position, the direction, and the posture after the correction) to the control server apparatus 200 as the detection result data (step S19).

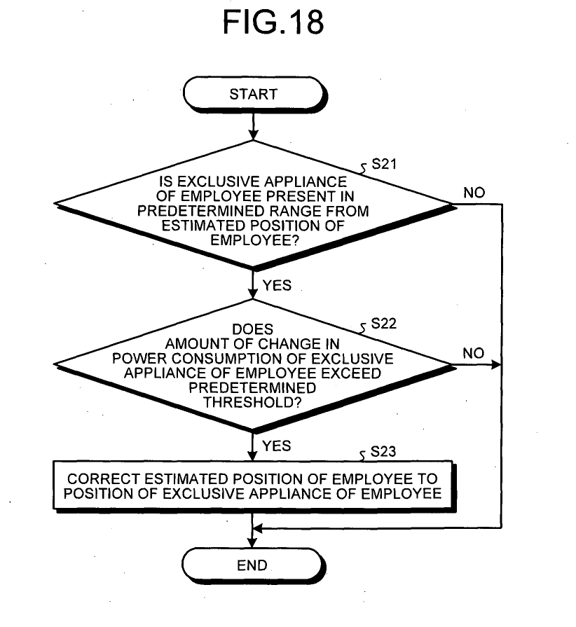

The following describes an example of position correction processing in which the position of the employee is corrected by the correction unit 104 on the basis of the power information and the positional information of the electrical appliance. FIG. 18 is a flowchart illustrating a procedure of the position correction processing of the embodiment. The example illustrated in FIG. 18 is a case where the power information of the exclusive appliance the employee exclusively uses is acquired as the power information used for the position correction processing.

First, the correction unit 104 determines whether the exclusive appliance of the employee is present in a predetermined range from the position of the employee estimated by the position estimation unit 102 on the basis of the positional information of the electrical appliance stored in the storage unit 110 (step S21). If no exclusive appliance of the employee is present in the predetermined range from the position of the employee estimated by the position estimation unit 102 (No at step S21), the correction unit 104 ends the processing without any change.

If the exclusive appliance of the employee is present in the predetermined range from the position of the employee estimated by the position estimation unit 102 (Yes at step S21), the correction unit 104 determines whether an amount of change in power consumption exceeds a predetermined threshold on the basis of the power information of the exclusive appliance (step S22). If the amount of change in power consumption of the exclusive appliance is equal to or smaller than the predetermined threshold (No at step S22), the correction unit 104 ends the processing without any change.

If the amount of change in power consumption of the exclusive appliance exceeds the predetermined threshold (Yes at step S22), the correction unit 104 corrects the position of the employee estimated by the position estimation unit 102 to the position of the exclusive appliance of the employee (step S23).

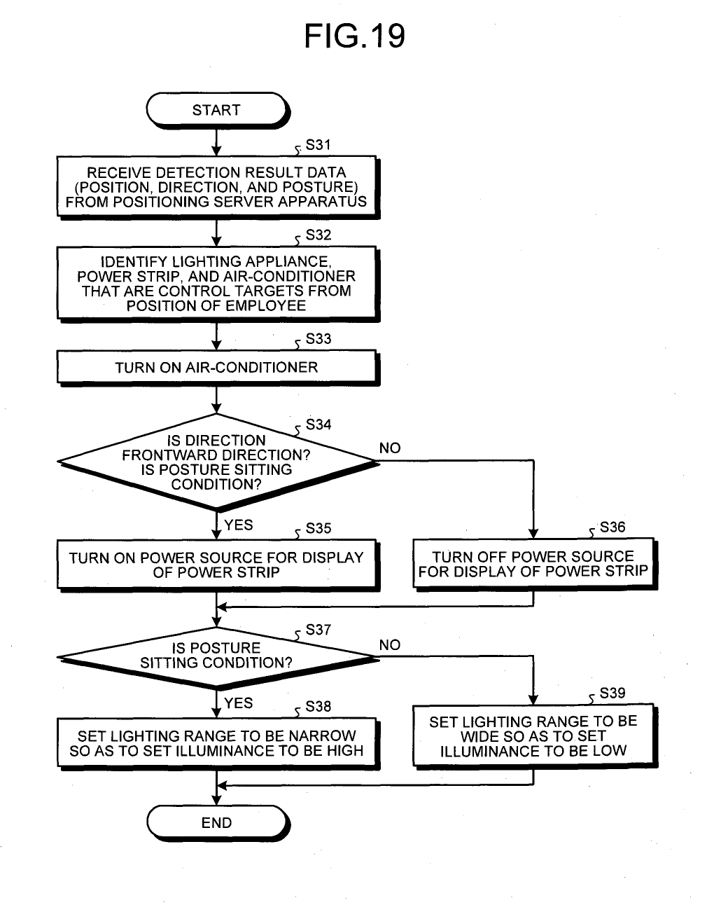

Next, the following describes appliance control processing by the control server apparatus 200. FIG. 19 is a flowchart illustrating a procedure of the appliance control processing of the embodiment.

First, the communication unit 201 receives from the positioning server apparatus 100 the position, the direction, and the posture of the employee in the room as the detection result data (step S31). Then, the respective control units 211, 213, and 215 of the appliance control unit 210 identify the LED-lighting appliance 500, the power strip 600, and the air-conditioner 700 serving as the control targets from the position of the employee included in the received detection result data (step S32).

More specifically, the lighting appliance control unit 211 refers to the positional information stored in the storage unit 220 and identifies the LED-lighting appliance 500 installed on the desk corresponding to the absolute position as the control target. The outlet control unit 213 refers to the positional information stored in the storage unit 220 and identifies the power strip 600 installed in the vicinity of the desk corresponding to the absolute position as the control target. The air-conditioner control unit 215 refers to the positional information stored in the storage unit 220 and identifies the air-conditioner 700 installed for the group in which the desk corresponding to the absolute position is present as the control target.

Then, the air-conditioner control unit 215 performs control to turn on the power source of the identified air conditioner 700 (step S33).

Then, the outlet control unit 213 determines whether the direction in the received detection result data is the frontward direction and the posture in the received detection result data is the sitting condition (step S34). If the direction is the frontward direction and the posture is the sitting condition (Yes at step S34), the outlet control unit 213 performs control to turn on the switch of the outlet to which the display is connected in the power strip 600 identified at step S32 (step S35).

If the direction is the backward direction or the posture is the standing condition at step S34 (No at step S34), the outlet control unit 213 performs control to turn off the switch of the outlet to which the display is connected in the power strip 600 identified at step S32 (step S36).

Then, the lighting appliance control unit 211 determines again whether the posture in the received detection result data is the sitting condition (step S37). If the posture is the sitting condition (Yes at step S37), the lighting appliance control unit 211 sets the lighting range of the LED-lighting appliance 500 identified at step S32 to be narrower than a predetermined range so as to control the illuminance to be higher than a predetermined threshold by dimming control, which is described later (step S38).

If the posture is the standing condition at step S37 (No at step S37), the lighting appliance control unit 211 sets the lighting range of the LED-lighting appliance 500 identified at step S32 to be wider than the predetermined range so as to control the illuminance to be lower than the predetermined threshold by dimming control, which is described later (step S39).

The respective control units 211, 213, and 215 of the appliance control unit 210 may be structured so as to perform control other than the control described above on each appliance serving as the control target.

The respective control units 211, 213, and 215 of the appliance control unit 210 may be structured so as to perform control on each appliance serving as the control target on the basis of the motion condition of the employee of whether it is the squatting motion or the standing up motion, whether it is the motion of changing the direction or the motion of returning the direction in the sitting condition, whether it is the motion of changing the direction of the eyes in the upward direction (looking up motion) or the motion of returning direction of the eyes in the sitting condition, or whether it is the motion of changing the direction of the eyes in the downward direction (looking down motion) or the motion of returning the direction of the eyes in the sitting condition.

Examples of the respective motions, the appliance serving as the control target, and the control method in such cases are as follows. These motions are possible motions when a condition is assumed in which the employee sits in front of a desk, and the appliance serving as the control target includes a PC or a display of the PC, a desk light, and an electric table fan corresponding to an individual air-conditioner.

For example, the outlet control unit 213 can be structured so as to turn off the switch of the outlet to which the power source of the PC is connected when it is determined from the received detection result data that the squatting motion continues over a certain period of time in the case that the employee sits in front of the desk. A mode control unit that controls modes of the appliance is provided to the appliance control unit 210, and the mode control unit can be structured so as to cause the display of the PC to proceed to a standby mode.

The mode control unit can be structured so as to cause the PC to proceed to the stand-by mode when the standing condition continues over a certain period of time from the detection of the standing up motion after the sitting condition, or the outlet control unit 213 can be structured so as to simultaneously turn off the switch of the outlet to which the power source of the display is connected.

The following control can be cited as an example of the motions of changing the facing directions. The outlet control unit 213 and the mode control unit can be structured so as to achieve the following examples. When a change in facing direction of the face or the upper body is detected after a condition where the employee sits in front of the desk, and this condition continues over a certain period of time, it may be a case where the employee has a conversation with another employee sitting next to the employee, for example, and thus the PC, the display, and the lighting appliance such as the desk light are set to the standby condition or turned off. When it is detected that the facing direction of the employee returns to the original condition or the posture of the employee returns to the original posture, the PC, the display, and the lighting appliance such as the desk light are turned on.

When the employee reads documents on the desk, the employee may perform a looking down motion while when the employee is searching for or thinking of ideas, the employee may perform a motion of looking up at a ceiling. The outlet control unit 213 and the mode control unit can be structured so as to cause the PC to proceed to the standby mode or to turn off the display when the looking up motion or the looking down motion is continuously detected over a certain period of time. In addition, the outlet control unit 213 may be structured to control the desk light so as not to be turned off in the looking down motion.

In the embodiment, the power control of the appliance is performed by identifying the position of the employee with an accuracy of a shoulder width and by detecting the direction and the posture of the employee as described above, thereby making it possible to perform the power control of the appliance with a higher accuracy and to achieve further power saving and energy saving while comfort of the employee and high efficiency of the work are maintained.

That is, the embodiment can not only detect the employee but also individually control the appliance the employee exclusively uses and the lighting appliance, the air-conditioner, and office appliance in the vicinity of the desk in front of which the employee sits and spontaneously grasp the electricity consumption of each employee.

In conventional techniques, it is unclear how power saving is done on an individual basis though the “visualization” of the power of a building, an office, the whole of a factory, and the whole of the office can be achieved. As a result, it is difficult to be aware of power saving unless in an imminent situation such as the use beyond an overall target value or an amount of power supply, for example, thereby not continuously promoting the power saving. However, the embodiment makes it possible to further achieve power saving while comfort of the employee is maintained and a decrease in efficiency of the task is prevented.

Furthermore, the embodiment makes it possible to further promote power saving in automatic control of appliance by not only controlling the employee and the appliance but also performing cooperative control between the appliances.

In the embodiment, the position of the employee estimated by the position estimation unit 102 is corrected using the power information collected for managing the power consumption of the electrical appliance, thereby making it possible to measure the position of the employee with a high accuracy employing a simple structure.

Because the appliance control system of the embodiment controls the appliance on the basis of the position and the motion condition of the employee, there is a fear that automatic power control becomes unstable if a difference occurs between the position of the employee grasped by the system and the position of the employee in a real space. In the appliance control system of the embodiment, the imaged image of the monitoring camera 400 is input to the positioning server apparatus 100. It is thus possible to correct the position of the employee using the imaged image of the monitoring camera 400. However, when the opportunity of imaging by the monitoring camera 400 is eliminated because the employee continues to stay in the room for a long period of time, a difference occurs in the position of the employee estimated by the position estimation unit 102.

The position of the employee estimated by the position estimation unit 102 may be corrected using various techniques such as short distance wireless communication including RFID and Bluetooth (registered trademark) and optical communication besides the monitoring camera 400. The use of such techniques only for correcting the position of the employee estimated by the position estimation unit 102 requires an extensive system, thereby causing a problem of an increase in cost and the like. In the embodiment, however, the position of the employee estimated by the position estimation unit 102 is corrected using the power information collected for managing the power consumption of the electrical appliance, thereby making it possible to measure the position of the employee with a high accuracy employing a simple structure.

The positioning server apparatus 100 and the control server apparatus 200 of the embodiment each include the control device such as a CPU, the storage devices such as a ROM and a RAM, the external storage devices such as an HDD and a CD drive device, the display device such as the display, and the input devices such as a keyboard and a mouse, and thus has a hardware configuration using a typical computer.

A detection program executed by the positioning server apparatus 100 of the embodiment and a control program executed by the control server apparatus 200 of the embodiment are recorded onto a computer readable recording medium in a format installable in or a file executable by a computer, and provided. Examples of the recording medium include CD-ROMs, flexible disks (FDs), CD-Rs, and digital versatile discs (DVDs).

The detection program executed by the positioning server apparatus 100 of the embodiment and the control program executed by the control server apparatus 200 of the embodiment may be stored on a computer connected to a network such as the Internet and provided by being downloaded through the network. The detection program executed by the positioning server apparatus 100 of the embodiment and the control program executed by the control server apparatus 200 of the embodiment may be provided or delivered through a network such as the Internet.

The detection program executed by the positioning server apparatus 100 of the embodiment and the control program executed by the control server apparatus 200 of the embodiment may be provided by being preliminarily stored in a ROM or the like.

The detection program executed by the positioning server apparatus 100 of the embodiment has a module structure including the above-described units (the communication unit 101, the position estimation unit 102, the motion condition detection unit 103, and the correction unit 104). In actual hardware, the CPU (processor) reads the detection program from the storage medium and executes the program. Once the program is executed, the respective units are loaded into a main storage device, so that the communication unit 101, the position estimation unit 102, the motion condition detection unit 103, and the correction unit 104 are formed in the main storage device.

The control program executed by the control server apparatus 200 of the embodiment has a module structure including the above-described units (the communication unit 201, the power consumption managing unit 202, the lighting appliance control unit 211, the outlet control unit 213, and the air-conditioner control unit 215). In actual hardware, the CPU (processor) reads the control program from the storage medium and executes the program. Once the program is executed, the respective units are loaded into a main storage device, so that the communication unit 201, the power consumption managing unit 202, the lighting appliance control unit 211, the outlet control unit 213, and the air-conditioner control unit 215 are formed in the main storage device.

### Example 1

Particularly, the power information of the respective desktop PCs was sent from the control server apparatus 200 to the positioning server apparatus 100, out of the electrical appliances connected to the power strips 600, and used for correcting the position of the employee by the correction unit 104. The installation positions of the respective desktop PCs were preliminarily determined, thereby making it possible to correct the position of the employee estimated by the position estimation unit 102 on the basis of a change in power consumption at the recovery of the desktop PC from the power saving mode or the shutdown by the employee with manual operation. Even if the employee continues to stay in the room for a long period of time, the desktop PC immediately proceeds to the standby mode when the employee leaves the desk, and the power consumption is changed by the recovery operation of the desktop PC by the employee with manual operation at the time when the employee returns to the desk again, thereby causing the position of the employee estimated by the position estimation unit 102 to be corrected by every recovery operation. As a result, the appliance control system was able to continue to grasp consistently the correct position of the employee.

### Example 2

No monitoring cameras 400 were provided as compared to example 1. In example 2, the position of the employee cannot be estimated until when the employee is at the desk and performs the recovery operation of the desktop PC because the reference position of the relative movement vector is not fixed, but once the employee performed the operation, the appliance control system was able to continue to grasp consistently the correct position of the employee.

### Example 3

Particularly, the power information of the chargers of the respective smartphones 300 installed on the respective desks was sent, out of the electrical appliances connected to the power strips 600, from the control server apparatus 200 to the positioning server apparatus 100 and used for correcting the position of the employee by the correction unit 104. The installation positions of the chargers of the respective smartphones 300 were preliminarily determined, thereby making it possible to correct the position of the employee estimated by the position estimation unit 102 on the basis of a change in power consumption when the smartphone 300 was connected to the corresponding charger.

### Example 4

In the examples (examples 1 to 3), the power information of all of the electrical appliances was transmitted by all of the power strips 600 to the control server apparatus 200 at about 10 second intervals. In such cases, it is impossible to correct the position of the employee correctly when the employee moves in about 10 seconds after the manual operation of the desktop PC in examples 1 and 2 or after the charging operation of the smartphone 300 in example 3. Thus, it is preferable to transmit the power information of the desktop PC and the charger of the smartphone 300 used for correcting the position of the employee to the control server apparatus 200 at a period (about one second or equal to or smaller than one second) shorter than that of the power information of other electrical appliances. In contrast, temporal resolution is not much required for the power information of the electrical appliance that is not used for correcting the position. It is better not to reduce the transmitting time intervals more than needed in view of reducing load of data communication. For example, in the example, the transmitting time intervals of the power information of the desktop PCs and the chargers of the smartphones 300 was one second while the transmitting time intervals of the power information of the other appliances was 10 seconds. As a result, the system was achieved that was capable of collecting minimum practical power information from all of the electrical appliances while the position of the employee was correctly corrected.

### Example 5

A lighting fixture having a human sensor was installed instead of the monitoring camera 400 as compared to example 1. The power source of the lighting fixture was connected to the power strip 600 so as to cause the power information of the lighting fixture to be transmitted from the power strip 600 to the control server apparatus 200. The employed human sensor, which detects a human by detecting infrared rays emitted from the human body, was a simple type, which has no special means such as to externally transmit the output value of the sensor. As a result, the positional accuracy of the employee who frequently entered and left the room was able to be enhanced more particularly than example 2. The transmitting time intervals of the power information of the lighting fixture were set to about 0.2 seconds taking into consideration a moving speed of a human who passes under the lighting fixture having the human sensor while the transmitting time intervals of the power information of the other electrical appliances were set to be the same as those of example 4.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth. The embodiment is an example applied to the appliance control system that controls the appliances in the room in accordance with the position and the motion condition of the employee. The present invention, however, can be used for various fields as a technique for correcting the estimated positions. In the embodiment, the position of the employee who performs tasks in the room is corrected. The position of a mobile object such as a human other than the employee or a working robot also can be corrected in the same manner.

### REFERENCE SIGNS LIST

1 Positioning apparatus
10 Acquisition unit
20 Estimation unit
30 Correction unit
40 Storage unit
100 Positioning server apparatus
101 Communication unit
102 Position estimation unit
103 Motion condition detection unit
104 Correction unit
110 Storage unit
200 Control server apparatus
201 Communication unit
202 Power consumption managing unit
210 Appliance control unit
211 Lighting appliance control unit
213 Outlet control unit
215 Air-conditioner control unit
220 Storage unit
300 Smartphone
400 Monitoring camera
500 LED-lighting appliance
600 Power strip
700 Air-conditioner

1. A positioning apparatus for measuring a position of a mobile object in a target area, the positioning apparatus comprising:
an acquisition unit configured to acquire power information of an electrical appliance in the target area;
a position acquisition unit configured to acquire a position of a mobile object on the basis of detection data obtained from the mobile object; and
a correction unit configured to correct the position of the mobile object on the basis of the power information acquired by the acquisition unit and positional information indicating a position of the electrical appliance.

2. The positioning apparatus set forth in claim 1, wherein the power information includes power consumption by the electrical appliance, and the acquisition unit acquires the power information indicating the power consumption of the electrical appliance.

3. The positioning apparatus set forth in claim 2, wherein the correction unit identifies the electrical appliance of which power consumed change amount exceeds a predetermined threshold, from among the electrical appliances of which power information is acquired, and the correction unit identifies the electrical appliance as being associated with the mobile object.

4. The positioning apparatus set forth in claim 2, wherein the electrical appliance is connected to a power strip that measures the power consumed by the connected electrical appliance and is capable of externally transmitting the measured power, and the acquisition unit acquires the power information from the power strip.

5. The positioning apparatus set forth in claim 4, wherein the correction unit identifies the electrical appliance associated with the mobile object from among the electrical appliances connected to the power strip.

6. The positioning apparatus set forth in claim 5, wherein the acquisition unit receives the power information of the electrical appliance associated with the mobile object, the electrical appliance being identified by the correction unit from among the electrical appliances connected to the power strip, with a period shorter than an acquisition period of the power information of the other electrical appliances connected to the power strip.

7. The positioning apparatus set forth in claim 5, wherein the electrical appliance associated with the mobile object is a personal computer.

8. The positioning apparatus set forth in claim 5, wherein the electrical appliance associated with the mobile object is a battery charger.

9. The positioning apparatus set forth in claim 5, wherein the position of the electrical appliance consists of a position of an operating unit of the electrical appliance associated with the mobile object.

10. The positioning apparatus set forth in claim 1, wherein the position acquisition unit acquires the position of the mobile object on the basis of at least one detection data detected by at least one of an acceleration sensor, an angular velocity sensor, and a geomagnetic sensor that are included in the mobile object.

11. The positioning apparatus set forth in claim 1, wherein the position of the electrical appliance consists of a position of a detection target area of a human sensor or an object detection sensor connected to the electrical appliance.

12. A computer readable storage medium including computer executable instructions configured to perform operation, the operation comprising:
acquiring power information of an electrical appliance in a target area;
acquiring a position of a mobile object on the basis of detection data obtained from the mobile object in the target area; and
correcting the position of the mobile object on the basis of the power information acquired by the acquisition unit and positional information indicating a position of the electrical appliance.

13. An appliance control system comprising:
a positioning apparatus for measuring a position of a mobile object in a target area; and
a control apparatus for controlling an electrical appliance being associated with the mobile object in the target area,
the positioning apparatus comprising:
an acquisition unit configured to acquire power information of an electrical appliance in the target area;
a position acquisition unit configured to acquire a position of a mobile object on the basis of detection data obtained from the mobile object in the target area; and
a correction unit configured to correct the position of the mobile object on the basis of the power information acquired by the acquisition unit and positional information indicating a position of the electrical appliance,
the control apparatus comprising:
a receiving unit configured to receive information indicating the corrected position of the mobile object from the positioning apparatus; and
an appliance control unit configured to control the electrical appliance on the basis of the corrected position of the mobile object.
